(19) United States
(12) Patent Application Publication
(10) Pub. No.: US 2024/0081180 A1
(43) Pub. Date: Mar. 14, 2024

(54) COMPACT FOLDING HANDLES AND ELECTRONIC CONTROL SYSTEM FOR HIGH-EFFICIENCY TURF MAINTENANCE TOOL

(71) Applicant: MTD PRODUCTS INC, Valley City, OH (US)

(72) Inventors: Mark Driscoll, Strongsville, OH (US); Adam Hiller, Jeromesville, OH (US); Khoa Nguyen, Rosedale, MD (US)

(21) Appl. No.: 18/367,557

(22) Filed: Sep. 13, 2023

Related U.S. Application Data
(60) Provisional application No. 63/406,451, filed on Sep. 14, 2022.

(51) Int. Cl. A01D 34/82; A01D 34/00; A01D 34/685; A01D 34/69

(52) U.S. Cl. CPC A01D 34/824; A01D 34/006; A01D 34/685; A01D 34/69; A01D 34/828; A01D 2034/6843

(57) ABSTRACT

A turf maintenance apparatus having folding handles facilitating compact storage is presented herein. The folding handles can be compressed or extended to adjust overall length and can rotate between an extended operator position and a folded storage position. Depending on implementation, the folding handles can be locked in the folded storage position and can also lock in the extended operator position. An operator presence device(s) can disable operation of a motor or engine when the handles are not locked in the extended operator position.

### CROSS-REFERENCE TO RELATED APPLICATION

This application for U.S. Patent claims the benefit of priority to U.S. Provisional Patent Application No. 63/406,451 entitled COMPACT FOLDING HANDLES FOR HIGH-EFFICIENCY TURF MAINTENANCE TOOL and filed Sep. 14, 2022, which is hereby incorporated by reference herein in its entirety and for all purposes.

### INCORPORATION BY REFERENCE

The following are hereby incorporated by reference within the present disclosure in their respective entireties and for all purposes: U.S. patent application Ser. No. 17/849,136 filed Jun. 24, 2022, U.S. Provisional Patent Application No. 63/214,547 filed Jun. 24, 2021, U.S. patent application Ser. No. 17/700,255 filed Mar. 21, 2022 and U.S. Provisional Patent Application No. 63/163,386 filed Mar. 26, 2021.

### FIELD OF DISCLOSURE

The disclosed subject matter pertains to a walk-behind lawn maintenance device with foldable handles; in an example, the foldable handles can lock in an extended position or in a folded position.

### BACKGROUND

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Modern maintenance machines also offer multiple options for a power source. The various advantages associated with electric motor engines, gasoline engines, natural gas engines, diesel engines and so forth also impact the mechanical design and engineering that go into these different maintenance devices. Meeting the various challenges associated with different maintenance and mowing applications and the benefits and limitations of different power sources results in a large variety of maintenance machines to meet consumer preferences.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure provide a walk-behind turf maintenance apparatus having compact folding handles. In an embodiment, the folding handles can partially collapse to facilitate extending and shortening a length of the folding handles. In further embodiments, the folding handles can lock in an extended position for use and can lock in a folded position for storage. In still further embodiments, the handles can both collapse and fold over a body of the walk-behind turf maintenance apparatus. In still further embodiments, an operator presence device can prevent starting or running of a motor of the turf maintenance apparatus when activated (or deactivated, depending on convention). The operator presence device can be activated in response to the handles being unlocked from a locked, extended position in an embodiment, preventing activation of a motor, engine or other power source when the handles are not in position for operation—as one example.

In an embodiment, disclosed is a walk-behind grass mowing apparatus that can comprise a mow deck formed within or secured to a support structure, at least one front wheel and at least one rear wheel secured to the support structure, a plurality of blades rotatably secured within the mow deck and a power source secured to the support structure that, when activated, provides mechanical force to the plurality of blades. In addition to the foregoing, the walk-behind grass mowing apparatus can comprise a power source secured to the support structure that, when activated, provides mechanical force to the plurality of blades. In addition, the operator handle can comprise an upper portion, a lower portion, a cross-member extending between left and right segments of the upper portion or the lower portion, and a mount structure that secures the operator handle to the support structure. In various embodiments, the upper portion is movable along the lower portion between a fully extended position and a compressed position. In further embodiments, the cross-member includes a locking mechanism that locks the upper portion from moving along the lower portion in at least one of: the fully extended position or the compressed position. In yet another embodiment, the cross-member includes a release that unlocks the locking mechanism and permits movement of the upper portion along the lower portion between the fully extended position and the compressed position.

Further embodiments disclose an operator handle for a turf maintenance apparatus, comprising an upper handle portion comprising an operator grip and a lower handle portion comprising a hollow tube within which the upper handle portion can move between a compressed position and an extended position. Further, the operator handle can comprise a mount structure comprising one or more fastener supports for fixedly attaching the mount structure to an apparatus, wherein the lower handle portion is rotatably secured near a base thereof to the mount structure and is rotatable between an upright position and a folded position relative to the apparatus, and wherein the mount structure further comprises a first locking mechanism to lock the lower handle portion in at least one of: the upright position or the folded position preventing rotation of the lower handle portion when locked by the locking mechanism. In further embodiments, the operator handle can comprise a cross member positioned at an intersection of the upper handle portion and the lower handle portion and through which the upper handle portion engages the hollow tube of the lower handle portion, and the cross member further including a release configured to unlock the lower handle portion from the folded position.

In additional embodiments, embodiments of the present disclosure provide a cross member for an operator handle of a turf maintenance apparatus. The cross member can comprise a cross-member body having an exterior and an interior, wherein the interior engages with a first elongated structure of the operator handle at one end of the cross-member body and engages with a second elongated structure of the operator handle at a second end of the cross-member body. Moreover, the cross member can comprise a first locking structure seated within the interior of the cross-member body that engages an opening in a lower portion of the first elongated structure and also engages a second opening in an upper portion of the first elongated structure, in response to the second opening being aligned with the opening, to lock the upper portion of the first elongated structure in a fixed position relative the lower portion of the first elongated structure. Further, the cross member can comprise a mechanically biased release actuator seated within the interior and coupled to the first locking structure and operable to drive the first locking structure toward the one end of the cross-member body in response to the mechanical bias and engage both the opening and the second opening in response to the second opening being aligned with the opening. Still further, the cross member can comprise a release exposed to the exterior of the cross-member body and coupled to the mechanically biased release actuator such that, when activated to a first activation position, the release moves the mechanically biased release actuator against the mechanical bias and removes the first locking structure from the second opening and frees the upper portion of the first elongated structure to move relative to the lower portion of the first elongated structure.

In additional embodiments, disclosed is a base for securing an operator handle to a walk-behind turf maintenance apparatus. The base can comprise a support structure securing the base to the walk-behind turf maintenance apparatus and can comprise a base support secured to the support structure. In various embodiments, the base support further comprises a pivot fastener for rotatably securing the operator handle to the support structure between an extended position and a folded position and comprises a first base stop at the extended position of the operator handle that prevents the operator handle from rotating past the extended position and a second base stop at the folded position of the operator handle that prevents the operator handle from rotating past the folded position. Additionally, the disclosure can comprise a first locking structure located at a base of the operator handle in the extended position and configured to lock the operator handle in the extended position and prevent rotation of the operator handle out of the extended position, and moreover the disclosure can comprise a second locking structure located at the base of the operator handle in the folded position and configured to lock the operator handle in the folded position and prevent rotation of the operator handle out of the folded position.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 provides an example illustration of a high efficiency (HE) turf maintenance apparatus with handles in an extended position, in disclosed embodiments.

FIG. 2 depicts example elements of a handle structure for the HE turf maintenance apparatus of FIG. 1, according to further embodiments of the present disclosure.

FIG. 2A illustrates an example handle structure for the HE turf maintenance apparatus in a collapsed position according to still further embodiments.

FIG. 2B depicts a drawing of an example cross-member and release actuator for a locking handle of a HE turf maintenance apparatus, according to additional disclosed aspects.

FIG. 2C illustrates a drawing of a rear view of the example cross-member and release actuator for the locking handle in further aspects of the disclosure.

FIG. 2D illustrates a drawing of multi-stage movement of a disclosed release actuator in further aspects of the present disclosure.

FIG. 3 depicts an example support structure and cross member for the handle structure that facilitates one or more locking positions and a release for the handle structure.

FIG. 3A depicts a close-up view of one end of the example support structure of FIG. 3, according to one or more aspects of the disclosed embodiments.

FIG. 4 illustrates an example operation of a release mechanism for the example support structure of FIG. 3 in one or more aspects.

FIG. 5 depicts a close-up view of example release actuation on elements of the example support structure in another aspect(s).

FIG. 5A provides an image of an interior of a cross member for the handle structure showing interaction of parts contained therein, in further embodiments.

FIG. 6 illustrates an example handle-frame mount for securing the handle structure to the HE turf maintenance apparatus according to additional aspects disclosed herein.

FIGS. 7, 7A, 7B and 7C depict example operation of the handle-frame mount for unlocking from an extended position and moving and locking into a folded position.

FIGS. 8 and 9 depict a close-up view of one end of the example support structure facilitating release of a lock from the folded position, in a further disclosed aspect.

FIG. 9A illustrates an example of collapsible handles for a HE turf maintenance apparatus with multiple locked extended positions, in further aspects of the present disclosure.

FIG. 10 illustrates a sample effect on the handle-frame mount of the release of the lock from the folded position of FIGS. 8 and 9, in another aspect(s) of the disclosure.

FIG. 11 depicts elements of the handle-frame mount to facilitate return of the handle structure to an extended and locked position, in yet other aspects of the disclosure.

FIG. 12 provides an image of an electronic control module for controlling operations of an HE turf maintenance apparatus in yet other embodiments of the disclosure.

FIG. 13 provides an image of an alternative electronic control module for controlling operations of an HE turf maintenance apparatus in still other embodiments.

FIG. 13A shows an image of an electronic control module in operation according to still further embodiments of the disclosure.

FIG. 14 illustrates a front view of an operator grip and electronic control module of a HE turf maintenance apparatus according to another disclosed embodiment(s).

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to compact and folding handles for a power equipment machine are described herein, it should be understood that the disclosed machines, electronic devices and methods are not so limited and modifications may be made without departing from the scope of the present disclosure. The scope of the apparatuses and devices are defined by the appended claims, and all devices, that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine” and “power equipment machine” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheel barrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

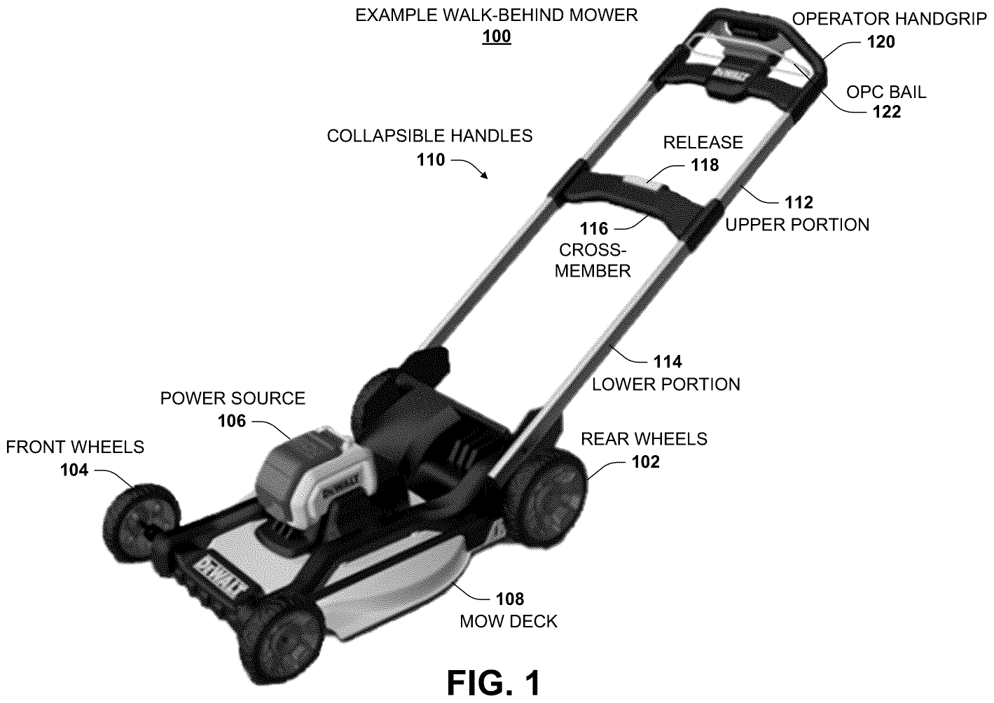

FIG. 1 illustrates a turf maintenance apparatus 100, e.g., a walk-behind mower in the depicted embodiment, according to one or more disclosed embodiments. Turf maintenance apparatus 100 can comprise one or more rear wheels 102, one or more front wheels 104 and a power source 106 secured to a mow deck 108. In some embodiments, turf maintenance apparatus 100 can be a high efficiency (HE) turf maintenance apparatus utilizing an electric motor for power source 106. The electric motor can receive electric power from a rechargeable electric supply (e.g., a battery(ies)) mounted on mow deck 108, or from an electric cable connected to an electric power source external to turf maintenance apparatus 100, or a combination of the foregoing in some embodiments. In other embodiments, turf maintenance apparatus 100 can be powered by any suitable combustion engine as an alternative to the electric motor. In particular embodiments, turf maintenance apparatus 100 can have handles that can fold over mow deck 108 of turf maintenance apparatus 100 (e.g., collapsible handles 110).

The mow deck 108 of turf maintenance apparatus 100 can be formed integral with, or formed separate from and attached to, a structural support (also referred to as a frame) in some embodiments. As illustrated, mow deck 108 is secured to front wheels 104, rear wheels 102 and collapsible handles 110, and can have the motive power source (e.g., electric motor, combustion engine, etc.) secured to mow deck 108 as well as one or more batteries. In an alternative embodiment, mow deck 108 can be embodied as a separate mower deck secured to a structural support (e.g., a mower frame), which in turn is secured to front wheels 104, rear wheels 102 and collapsible handles 110. Although not depicted, mow deck 108 can be connected to a bagging device that covers a turf ejection port and collects turf clippings into a receptacle portion of the bagging device. In an embodiment, such a bagging device can be as described in U.S. Provisional Patent Application No. 63/163,386 filed by the assignee of the present application for patent and incorporated by reference hereinabove.

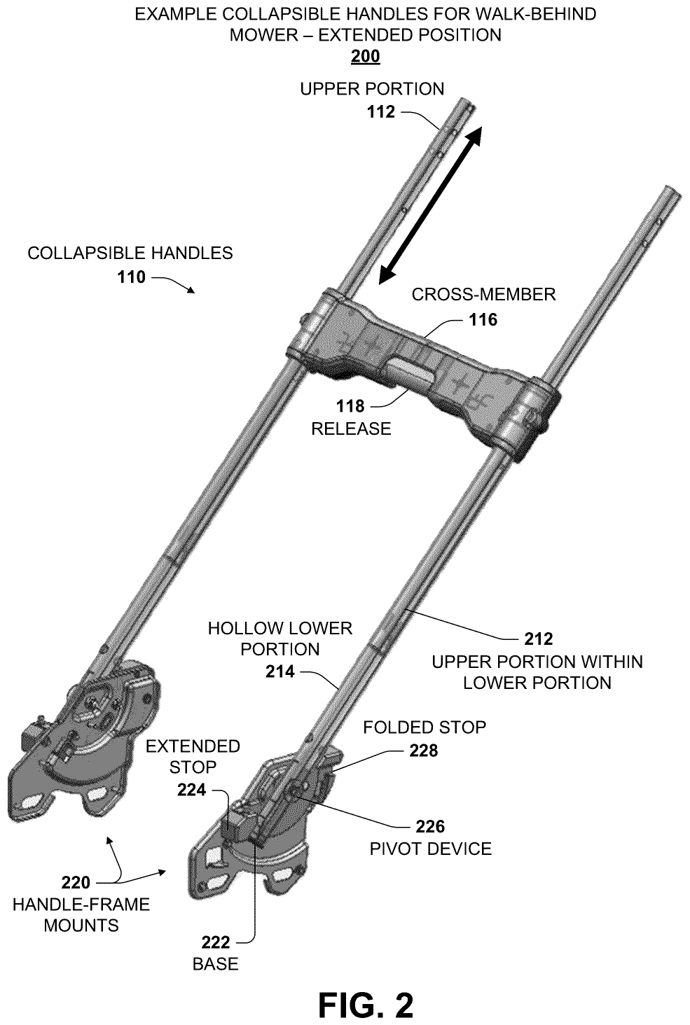

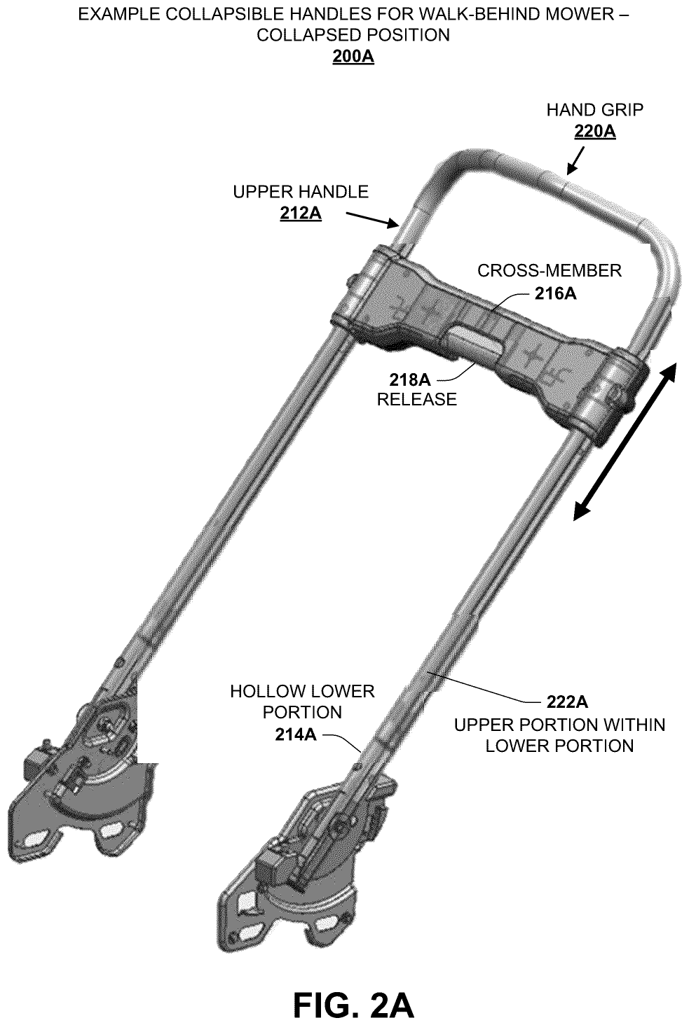

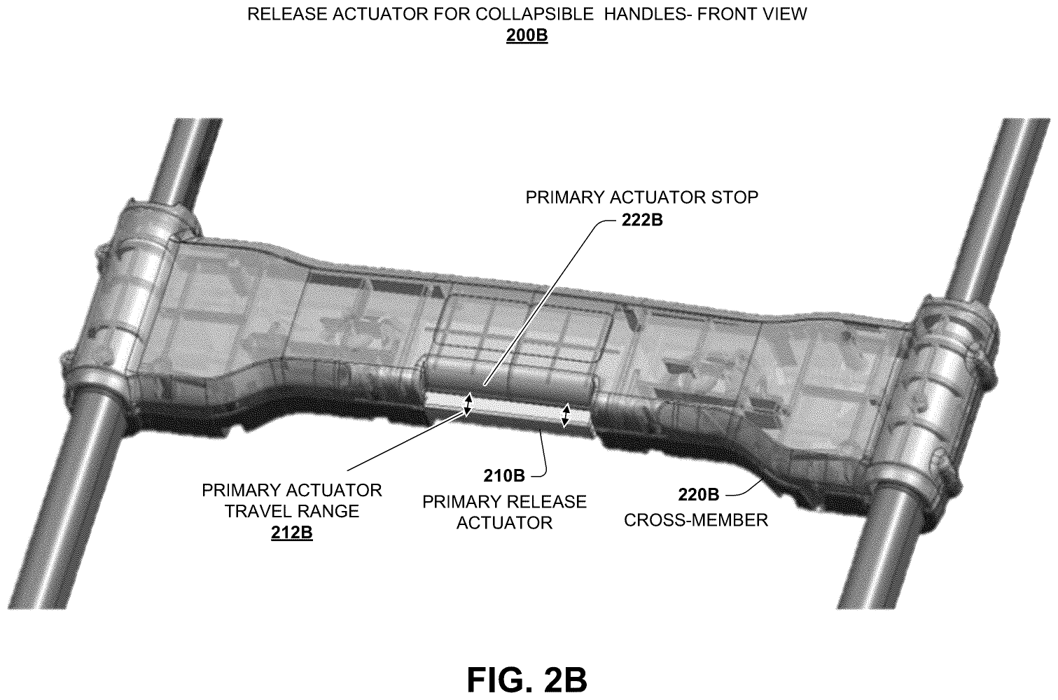

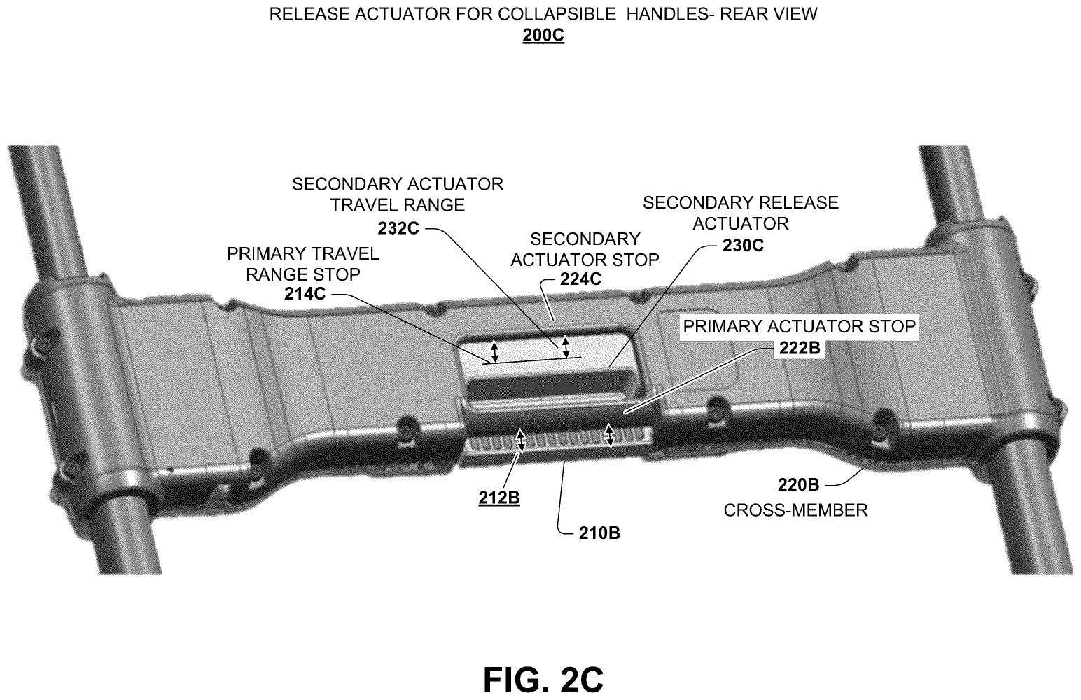

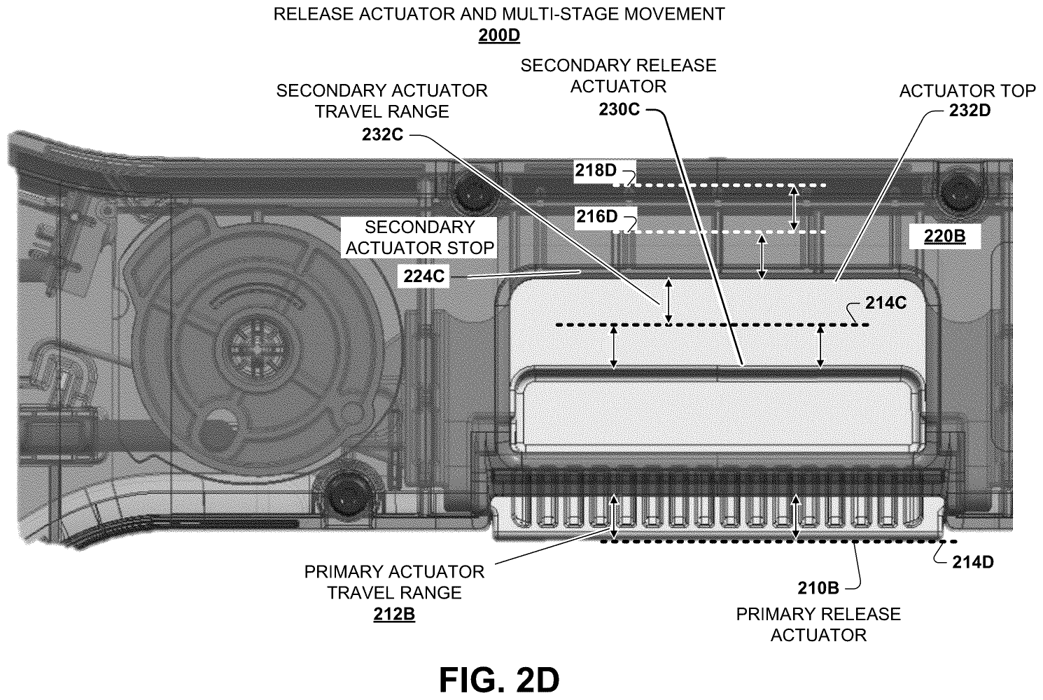

FIG. 1 illustrates collapsible handles 110 in an extended position (see also FIG. 2, infra). When the handles are collapsed (e.g., the upper portion 112 of collapsible handles 110 moved downward relative to the lower portion 114 of collapsible handles 110; see FIG. 2A, infra), collapsible handles 110 can be folded atop mow deck 108. In an embodiment(s), the collapsed handles 110 can have a length and width dimension equal to or less than a perimeter of front wheels 104 and rear wheels 102 when collapsed and folded, although the subject disclosure is not limited to this embodiment(s).

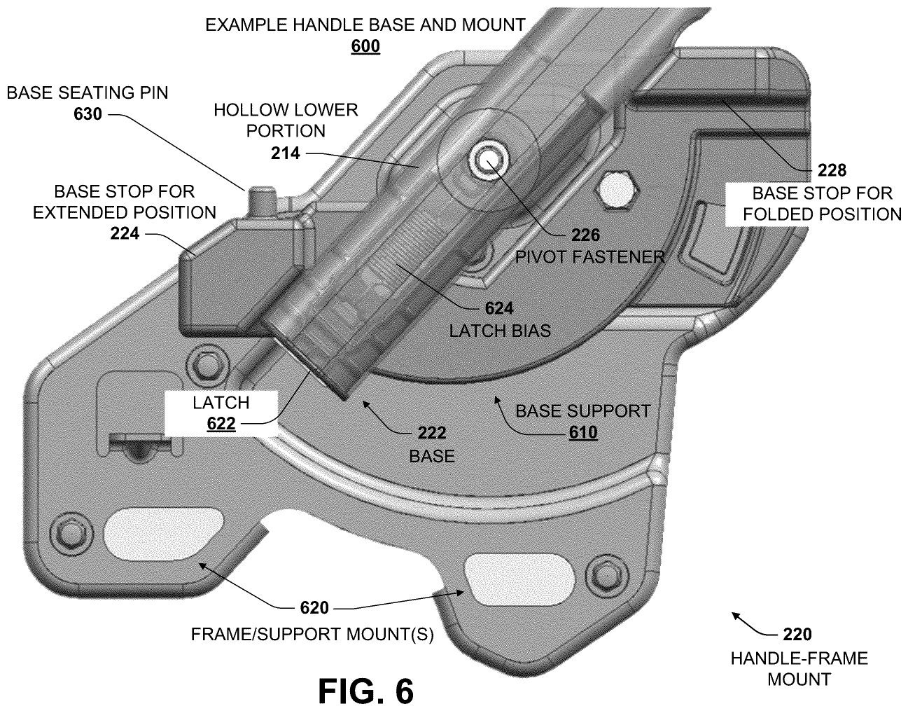

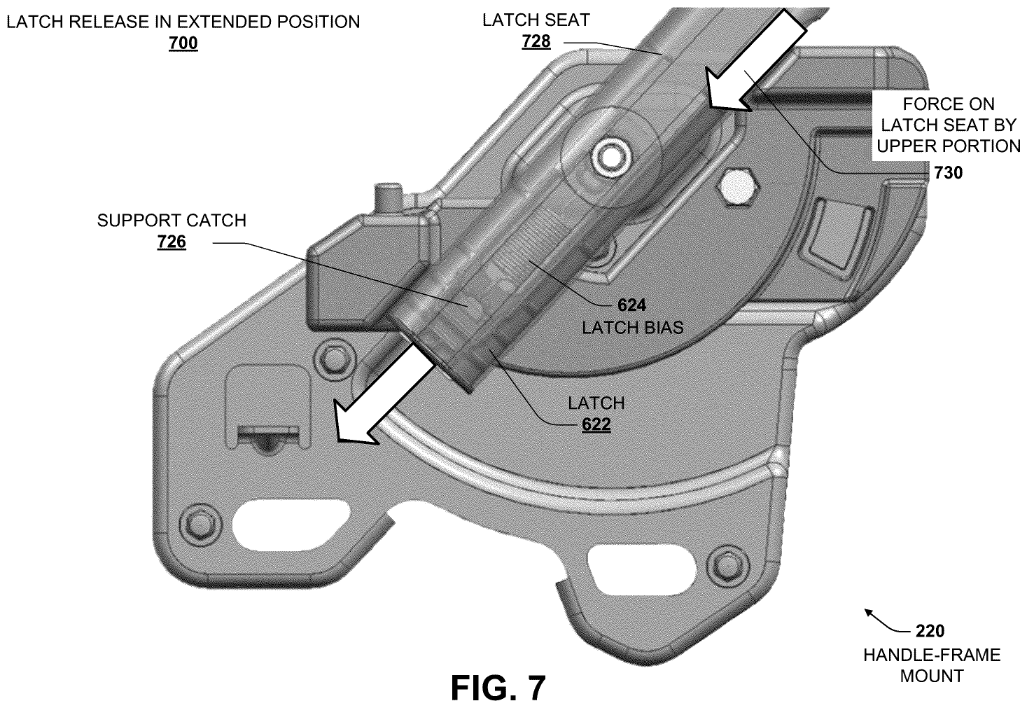

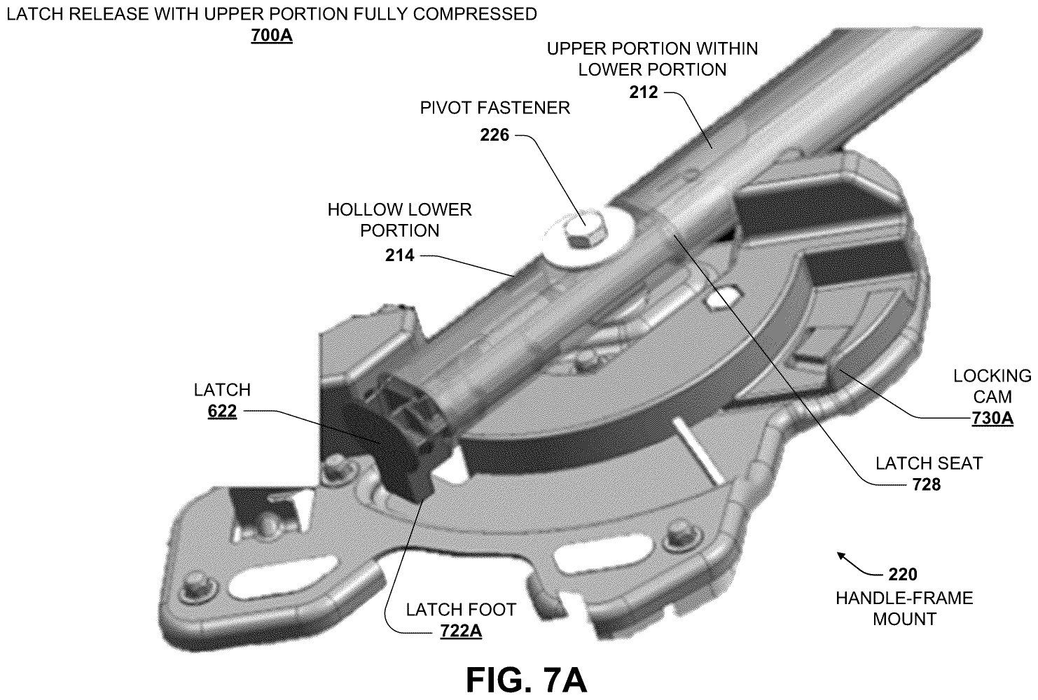

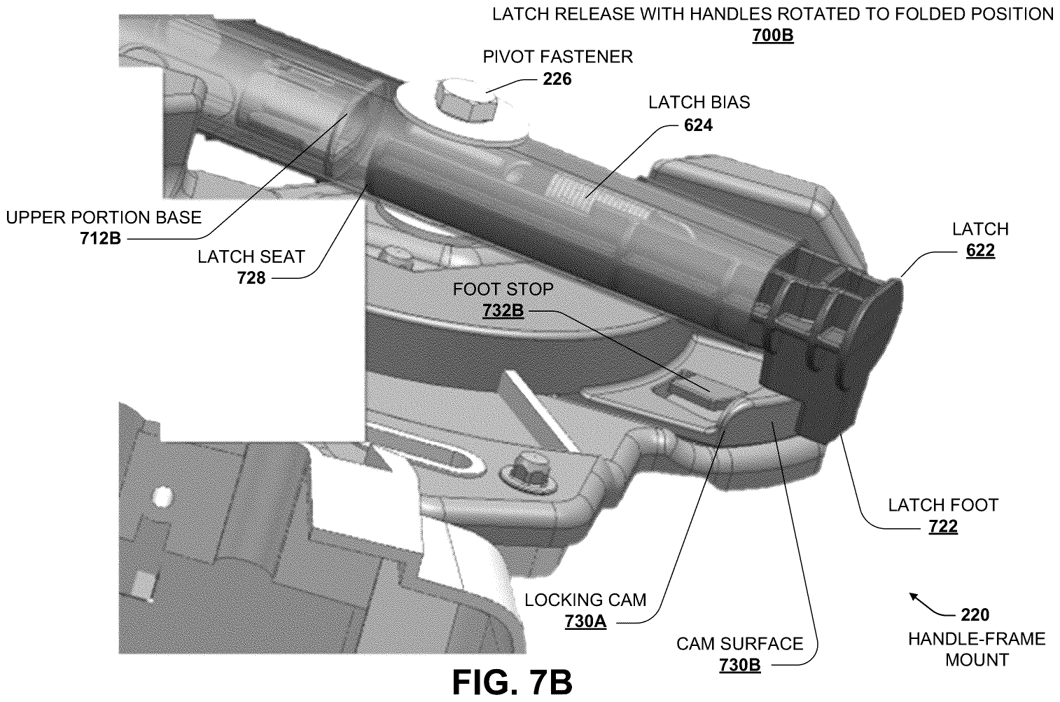

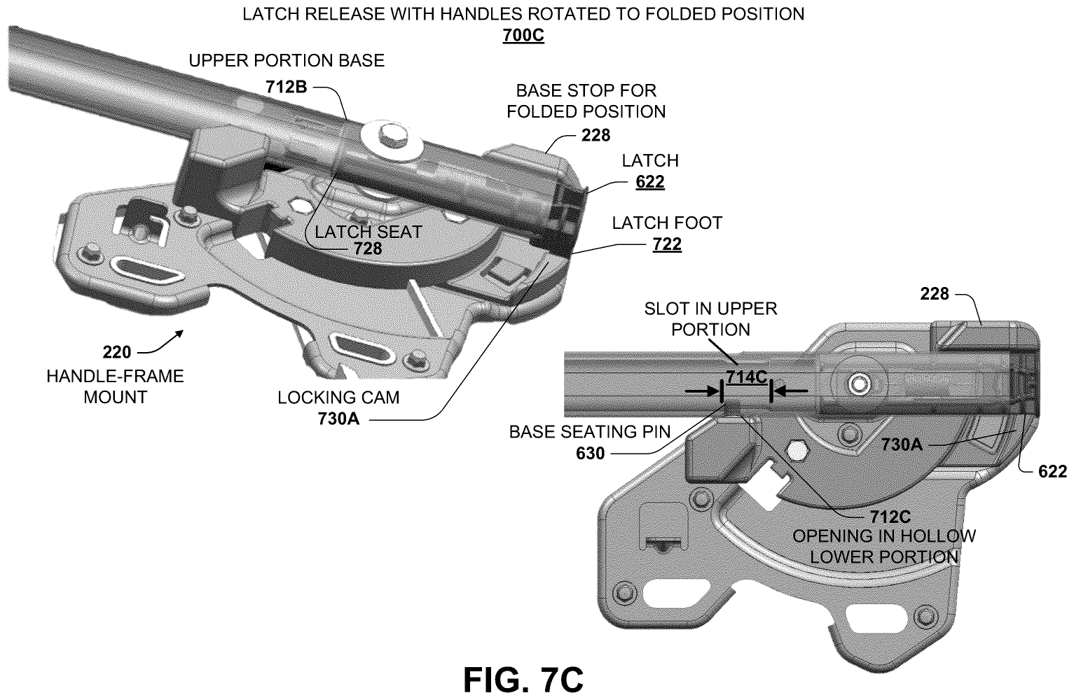

In one or more additional embodiments, collapsible handles 110 can lock in place in their extended position illustrated in FIG. 1 resulting in a locked extended position. In at least one embodiment, the locked extended position can lock upper portion 112 in a fixed relationship with lower portion 114, and can lock a base of collapsible handles 110 in the locked extended position, preventing the base and collapsible handles 110 from rotating out of the locked extended position (e.g., see FIGS. 2 and 2A, as well as FIGS. 6-7C, infra). Release 118 can be operable to unlock the upper portion 112 from the fixed relationship with lower portion 114, allowing an operator to move upper portion 112 relative lower portion 114. In response to activating release 118, an operator can move upper portion 112 downward relative to lower portion 114 shortening an overall length of collapsible handles 110. In further embodiments, compressing collapsible handles 110 into a fully compressed position (e.g., by pushing upper portion 112 fully into lower portion 114) can unlock a base of collapsible handles 110 from the locked extended position and allow collapsible handles to rotate between the extended position and the folded position (e.g., see FIGS., 6, 7, 7A, 7B, 7C, infra among others). In still further embodiments, the handles can also lock in place when in their folded position illustrated in FIG. 7C. A handle locking mechanism and one or more locking bases can facilitate locking and releasing of collapsible handles 110 between the locked extended and locked folded positions as described throughout this specification.

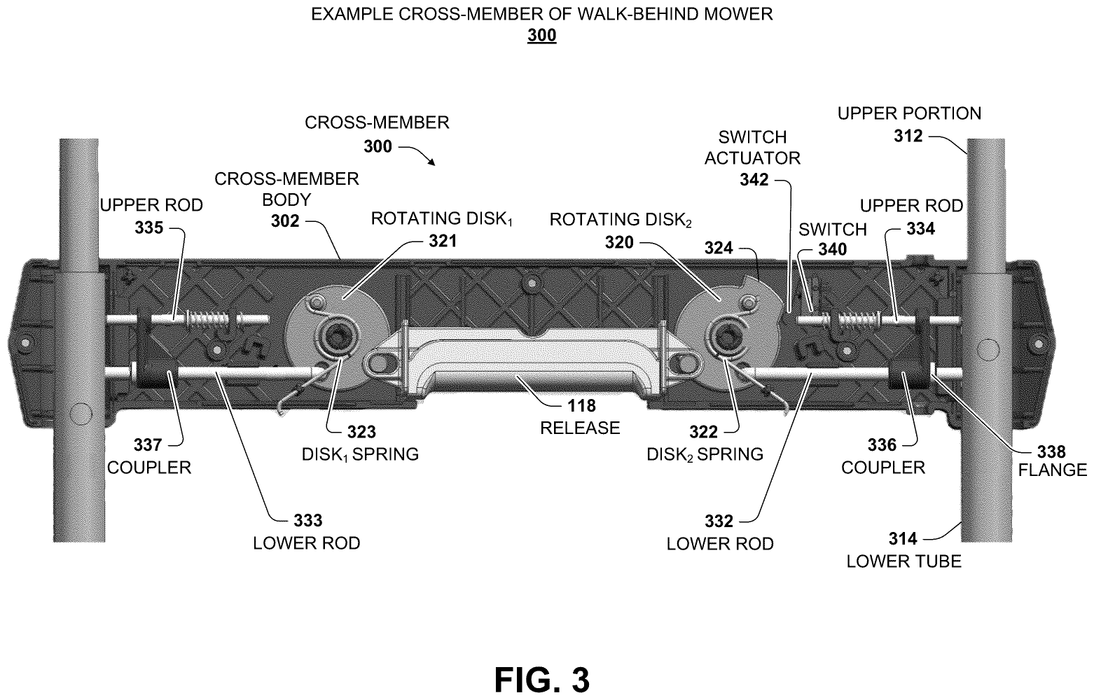

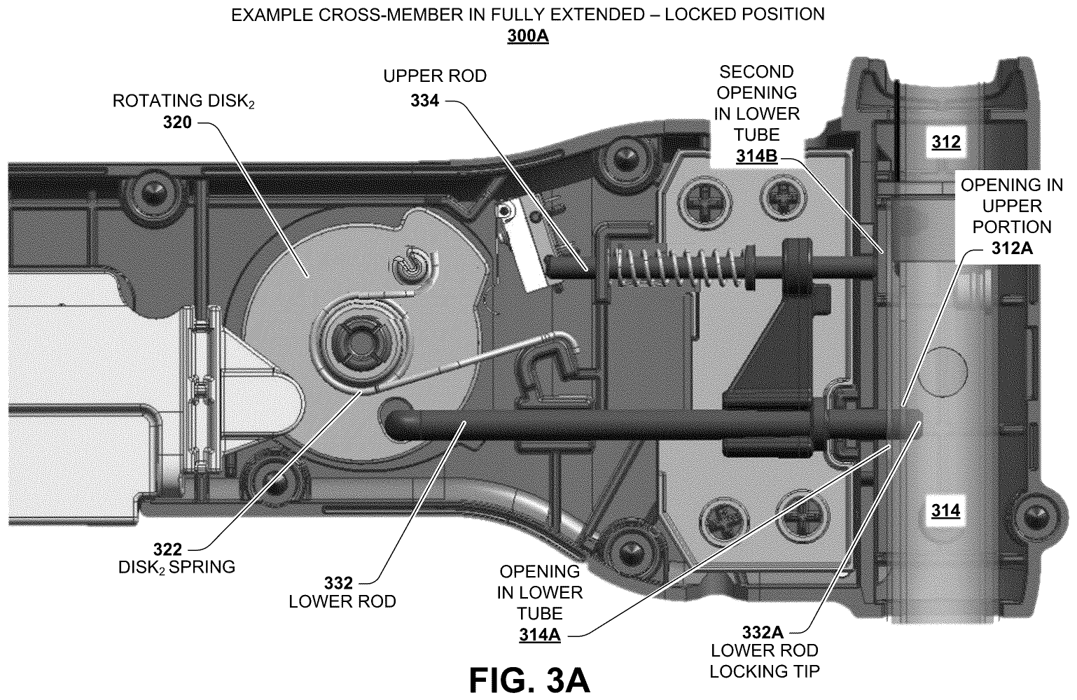

In yet other embodiments, one or more operator presence devices can be provided that prevent operation of the mechanical power source when one of the operator presence devices is deactivated. In at least one embodiment, an operator presence device can be operable with operator presence cable (OPC) bail 122 adjacent to the operator handgrip 120. When OPC bail 122 is held against a default position (e.g., a position maintained by a mechanical bias) the operator presence device can be disabled, so as to not prevent operation of a power source 106. When in the default position, the operator presence device can prevent operation of power source 106. In an alternative or additional embodiment, a second operator presence device can be located at least in part within an interior of collapsible handles 110, such as within cross-member 116 (e.g., see FIG. 3, infra). When collapsible handles 110 are in the locked extended position discussed above, the second operator presence device can be disabled, so as to not prevent operation of power source 106. Where multiple operator presence devices are provided for walk-behind mower 100, each of the devices must be disabled for power source 106 to operate.

FIG. 2 illustrates an example of collapsible handles 110 for a walk-behind mower in a locked extended position 200 according to one or more additional aspects of the present disclosure. Collapsible handles 110 include an upper portion 112 and hollow lower portion 214, and a cross-member 116 intersecting upper portion 112 and hollow lower portion 214. In at least some disclosed aspects, hollow lower portion 214 can have fixed length and upper portion 112 can move through cross-member 116 extending downward relative to hollow lower portion 214 toward handle-frame mounts 220, or can move outward relative to hollow lower portion 214 away from handle-frame mounts 220 as indicated by the double-ended arrow adjacent upper portion 112. In the embodiment(s) illustrated by FIG. 2, upper portion 112 can extend (e.g., slide, etc.) within an interior of hollow lower portion 214 as shown by upper portion within lower portion 212. In such embodiment(s), upper portion 112 can move into and out from hollow lower portion 214 between a fully compressed position and a fully extended position. In the fully compressed position upper portion 112 is fully inserted within hollow lower portion 214 and in the fully extended position upper portion 122 is removed from hollow lower portion 214 to a maximum extent permitted by collapsible handles 110.

Cross-member 116 can include one or more locking mechanisms configured to lock upper portion 112 in a fixed position(s) relative to lower portion 114 (e.g., see FIGS. 3, 8 and 9, infra). In some embodiments, a locking mechanism of collapsible handles 110 can lock upper portion 112 in an extended position relative to lower portion 114. In further embodiments, a locking mechanism of collapsible handles 110 can lock upper portion 112 in a compressed position relative to lower portion 114. In further embodiments, a first locking mechanism can lock upper portion 112 in the extended position and a second locking mechanism can lock upper portion 112 in the compressed position relative to lower portion 114, respectively. In at least one embodiment, a first locking mechanism can lock upper portion 112 relative to hollow lower portion 214 in a fully extended position and a second locking mechanism can lock upper portion 112 relative to hollow lower portion 214 in a fully compressed position. A release 118 can be provided to unlock the first locking mechanism and the second locking mechanism and allow upper portion 112 to move relative to hollow lower portion 214.

Collapsible handles 110 can include handle-frame mounts 220 provided to secure collapsible handles 110 to a disclosed maintenance apparatus, such as example walk-behind mower 100. A pivot device 226 can be provided to secure collapsible handles 110 at a base 222 thereof to handle-frame mounts 220. Collapsible handles 110, in one or more embodiments, can rotate about pivot device 226 between an extended stop 224 and a folded stop 228. Extended stop 224 can prevent base 222 of collapsible handles 110 from rotating past extended stop 224 and folded stop 228 can prevent base 222 of collapsible handles 110 from rotating past folded stop 228. In further disclosed embodiments, handle-frame mounts 220 can have one or more locking mechanisms to lock base 222 into an extended rotation position adjacent extended stop 224, or one or more locking mechanisms to lock base 222 into a folded rotation position adjacent folded stop 228. Accordingly, collapsible handles 110 can have locking mechanisms that one or more of: lock upper portion 112 in an extended position relative lower portion 114, lock upper portion 112 in a compressed position relative to lower portion 114, lock base 222 in an extended rotation position or lock base 222 in a folded rotation position, or a combination of the foregoing.

FIG. 2A illustrates collapsible handles 110 in a locked collapsed position 200A according to further aspects disclosed herein. In locked collapsed position 200A, upper handle 212A is shown fully compressed within hollow lower portion 214A. A hand grip 220A of upper handle 212A is atop cross-member 216A in the locked collapsed position 200A. In various embodiments, a release 218A can unlock upper handle 212A from the locked collapsed position 200A, allowing upper handle 212A to extend out of hollow lower portion 214A away from and above cross-member 216A to locked extended position 200 shown in FIG. 2, supra.

In one or more embodiments, when upper handle 212A is fully inserted into hollow lower portion 214A, a base 222 of hollow lower portion 214A can be unlocked from an extended rotation position. See, for example, FIGS. 6, 7 and 7A, infra. Once unlocked from the extended rotation position, collapsible handles 110 in the locked collapsed position 200A are free to rotate out of the extended rotation position, for instance, to the folded rotation position (e.g., see FIGS. 7B and 7C, infra) or there between.

FIG. 2B illustrates an example front view 200B of a cross member 220B and example release actuator for a collapsible locking handle, according to still further embodiments of the present disclosure. A primary release actuator 210B is shown extending beyond a fixed primary actuator stop 222B of cross-member 220B. Primary actuator stop 222B defines a first end (inward) of primary actuator travel range 212B. A second end (outward) of primary actuator travel range 212B can be as shown with primary release actuator 210B in its position as shown in FIG. 2B (or other suitable position downward and away from primary actuator stop 222B). The release actuator can be mechanically biased to the second end (outward) of primary actuator travel range 212B away from primary actuator stop 222B, e.g., by a spring, or other mechanical bias (e.g., see disk₁ spring 323 and disk₂ spring 322 of FIG. 3, infra). When fully depressed to primary actuator stop 222B, a first locking/unlocking effect can result within cross-member 220B (e.g., a lower rod locking tip 332A can be extracted from an opening in upper portion 312A of collapsible handles; see FIG. 3A, infra).

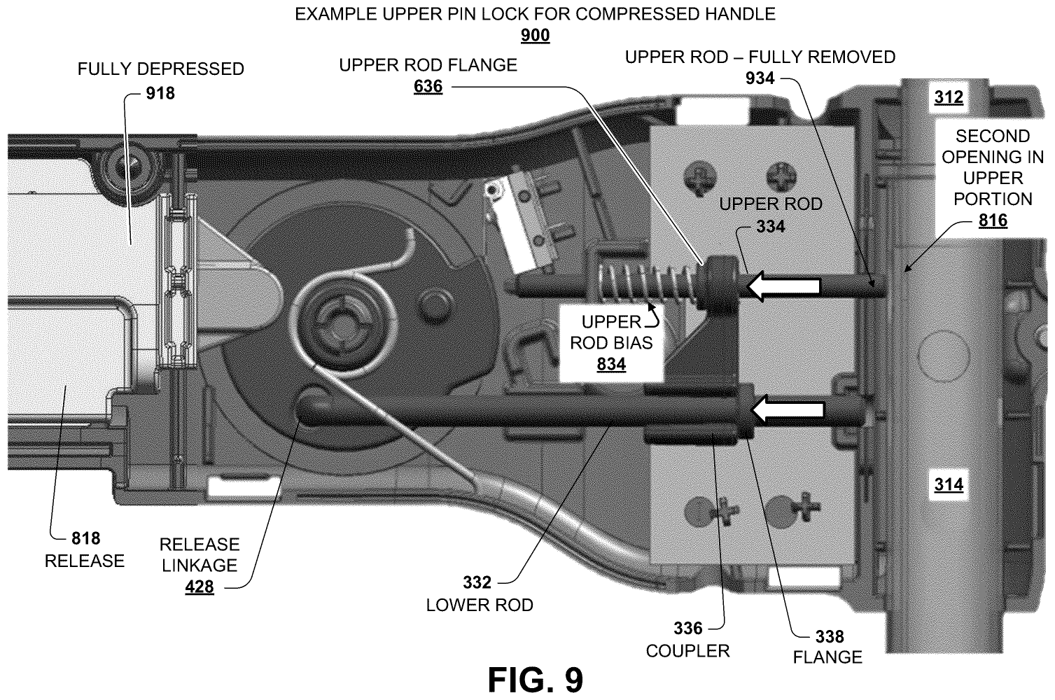

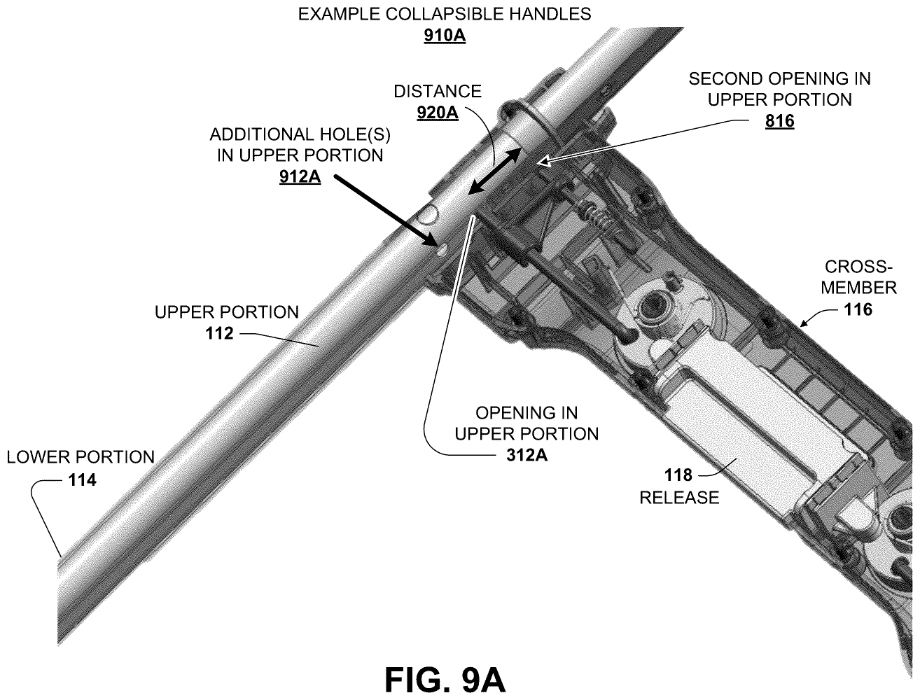

FIG. 2C illustrates a drawing of an example rear view 200C of cross member 220B and example release actuator, showing further aspects of the disclosed embodiments. Rear view 200C shows primary release actuator 210B extending beyond primary actuator stop 222B at a back side of cross-member 220B. Primary actuator travel range 212B defines a distance within cross-member 220B that the release actuator can be pushed by pressing primary release actuator 210B. A secondary release actuator 230C of the release actuator is moved upward from the position shown in FIG. 2C to primary travel range stop 214C in response to primary release actuator 210B being moved to primary actuator stop 222B. Secondary release actuator 230C can be utilized to push release actuator further within cross-member 220B beyond primary travel range stop 214C, up to secondary actuator stop 224C. The distance between primary travel range stop 214C and secondary actuator stop 224C defines secondary actuator travel range 232C. In response to secondary release actuator 230C reaching secondary actuator stop 224C a second locking/unlocking effect can result within cross-member 220B (e.g., see FIG. 9, infra, showing upper rod 334 fully removed from second opening in upper portion 816).

FIG. 2D depicts a rear view 200D of a release actuator and multi-stage movement thereof within a cross-member of a disclosed collapsible handle. Stages of the multi-stage movement can be correlated with locking or unlocking actions of a disclosed collapsible handle.

As shown, primary release actuator 210B can be mechanically biased to a first position 214D, correlated with an outer surface of primary release actuator 210B as shown. The release actuator can be pushed into cross-member 220B (against a mechanical bias) a distance defined by primary actuator travel range 212B in response to a (upward) force applied at primary release actuator 210B. This moves secondary release actuator 230C to primary travel range stop 214C and moves an upper surface of the release actuator defined by actuator top 232D to first internal stop 216D within cross-member 220B. A first locking/unlocking effect on an associated collapsible handle (e.g., freeing upper portion 112 to slide within hollow lower portion 214) can be implemented in response to the release actuator being moved the distance defined by primary actuator travel range 212B.

The release actuator can be pushed into cross-member 220B a second distance defined by secondary actuator travel range 232C in response to a force applied at secondary release actuator 230C. This moves secondary release actuator 230C adjacent to secondary actuator stop 224C and moves actuator top 232D to second internal stop 218D within cross-member 220B. A second locking/unlocking effect on the associated collapsible handle (e.g., locking upper portion 112 in a compressed position within hollow lower portion 214) can be implemented in response to the release actuator being moved the distance defined by secondary actuator travel range 232C.

FIG. 3 depicts an example cross-member 300 for operator handles of a disclosed walk-behind mower apparatus, according to one or more additional embodiments of the present disclosure. Cross-member 300 includes a cross-member body 302 that can seat conformally with a first elongated member of the operator handles on one end (e.g., right side) of cross-member body 302 and can seat conformally with a second elongated member of the operator handles on a second end (e.g., left side) of cross-member 300. The elongated members of the operator handles can include an upper portion 312 and a lower tube 314 in aspects of one or more disclosed embodiments. In various embodiments, upper portion 312 can move into or out from lower tube 314 to facilitate the operator handles transitioning between an extended position of the operator handles and a compressed position of the operator handles, as described throughout the specification.

Cross-member body 302 can facilitate movement of upper portion 312 relative lower tube 314 based on its interior shape and the engagement of cross-member body 302 with the operator handles. As an example, cross-member body 302 can be secured in a fixed position relative to lower tube 314. Upper portion 312 can then extend into and out from lower tube 314 between a fully compressed position (e.g., extended into lower tube 314 to a maximum extent) and a fully extended position (e.g., moved out from the lower tube 314 to a maximum extent). The subject disclosure is not so limited however, and different mechanisms for compressing (or collapsing) and extending the operator handles are within the scope of the present disclosure. For instance, cross-member body 302 can be secured in a fixed position relative to upper portion 312 and can move with upper portion 312 as it extends into lower tube 314 and moves out from lower tube 314 between the fully compressed and fully extended positions. As another example, upper portion 312 can be hollow and can slide over lower tube 314 (which can be hollow or non-hollow in this example) between the fully compressed position and the fully extended position. This can be implemented with cross-member body 302 secured to upper portion 312 as stated previously. In yet other examples, upper portion 312 can move alongside or adjacent lower tube 314 (instead of, for instance, sliding within or around). In still other examples, the operator handles can fold at one or more joints to collapse or compress to the fully compressed position and unfold to extend to the fully extended position.

As shown, cross-member 300 can include one or more lower rods, shown as lower rod 332 at a first end of cross-member 300 and lower rod 333 at a second end of cross-member 300. In at least one disclosed aspect, cross-member 300 can have a single lower rod at the first end or second end rather than two lower rods as shown. In the following description, the one or more lower rods—depending on design choice—are referred to collectively as lower rod(s) 332, 333 and include aspects of cross-member 300 with a single lower rod and multiple lower rods (similar syntax used herein also implies one or more members of a named set, the lower rod(s) in this instance, except where explicit to the contrary).

Lower rod 332 can have a first end extending into a hole in lower tube 314 where lower rod 332 meets lower tube 314 as shown in FIG. 3. Additionally, lower rod 332 can have its first end extend into a hole in upper portion 312 when upper portion 312 is positioned relative to lower tube 314 such that the hole in upper portion 312 aligns with the hole in lower tube 314. (See also FIG. 3A, infra, showing a partially translucent view of lower tube 314 and upper portion 312). Lower rod 332 can be mechanically biased such that its first end extends into the hole in lower tube 314 and into the hole in upper portion 312 (when properly aligned with the hole in lower tube 314). In the embodiment(s) illustrated in FIG. 3, the mechanical bias can be provided by a disk₂ spring 322 coupled to a rotating disk₂ 320 that interacts with a second end of lower rod 332. Disk₂ spring 322 can provide a counterclockwise force on rotating disk₂ 320 which in turn translates the force onto lower rod 332 in a direction toward lower tube 314. In other aspects of disclosed embodiments, different mechanical bias can be used, directly or indirectly on lower rod 332, and any suitable device to mechanically bias lower rod 332 toward the hole in lower tube 314 (and the hole in upper portion 312). Examples of suitable mechanical bias can include one or more: coil spring, torsion spring, leaf spring, rotating spring, cantilever spring, tension spring, flat spring, serpentine spring, garter spring, compression spring, hollow tubing spring, arc spring, volute spring, balance spring, v-spring or door-lock spring, Belleville washer, gas spring, mainspring, negator spring, marcelled wave spring, or any other suitable mechanical bias known in the art or reasonably conveyed to one of skill in the art by way of the context provided herein, is considered within the scope of the present disclosure.

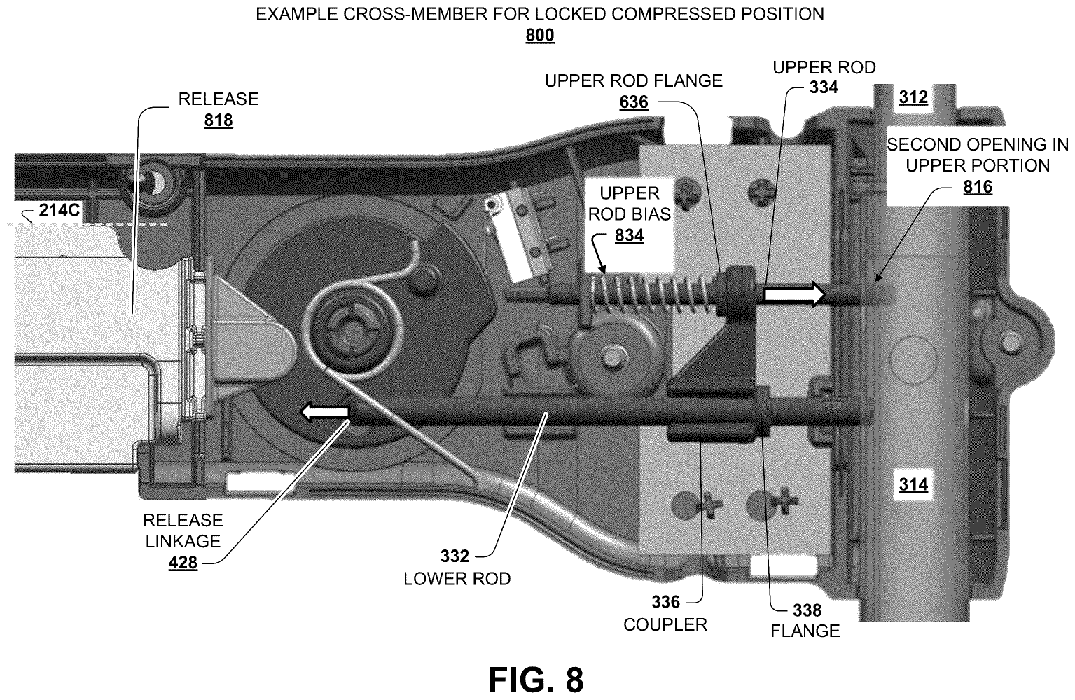

Cross-member 300 includes a release 118 physically coupled to rotating disk₂ 320. When actuated, such as by being depressed, switched, shifted, rotated, etc., release 118 causes rotating disk₂ 320 to rotate clockwise against mechanical bias of disk₂ spring 322 and pull lower rod 332 away from lower tube 314. In some aspects, release 118 can be actuated a first amount that rotates rotating disk₂ 320 an angle suitable to remove lower rod 332 from a hole in upper portion 312, but that does not cause a coupler 336 seated on lower rod 332 to engage a flange on an upper rod 334 and move (or significantly move) upper rod 334 engaged with coupler 336 (see also FIGS. 8 and 9, infra).

In response to release 118 being de-actuated—or returned to an original non-depressed/switched/shifted/rotated, etc. position—rotating disk₂ 320 can conditionally be returned by disk₂ spring 322 in a counter-clockwise orientation to an original orientation of rotating disk₂ 320. In some aspects, rotating disk₂ 320 can be tied to lower rod 332, and where lower rod 332 cannot move into a hole in upper portion 312 to restore an original position of lower rod 332, rotating disk₂ 320 will also be prevented from acquiring the original orientation of rotating disk₂ 320. In such aspects, where upper portion 312 is not in a position that aligns the hole in upper portion 312 with the hole in lower tube 314, lower rod 332 and rotating disk₂ 320 will not return to the original position and original orientation, respectively. Accordingly, release 118 will not be de-actuated and returned to the original non-depressed/switched/shifted/rotated position when the hole in upper portion 312 is not aligned with the hole in lower tube 314, in such aspects. In an embodiment(s), the hole in upper portion 312 aligns with the hole in lower tube 314 when operator handles are in the fully extended position. In the fully extended position then, lower rod 332 can be driven to its original position by disk₂ spring 322 and rotating disk₂ 320, allowing release 118 to return to a non-actuated position.

In some disclosed aspects, cross-member 300 can include lower rod 333 coupled to rotating disk₁ 321, which is also coupled to release 118. When actuated, release 118 rotates rotating disk₁ 321 against a mechanical bias provided by disk₁ spring 323 and removes lower rod 333 from a hole in an associated upper portion of operator handles adjacent to lower rod 333. Where release 118 is actuated to remove lower rod 332 and lower rod 333 from respective holes in the upper portion of the operator handles, the upper portion is freed to move relative to lower tube 314 (e.g., to a compressed or fully compressed position). In response to the upper portion of operator handles returning to a fully extended position, in some aspects of the disclosed embodiments, holes in the upper portion re-align with lower rod 333 and lower rod 332 allowing disk₂ spring 322 and disk₁ spring 323 to push lower rod 332 and lower rod 333 into the holes in upper portion, thereby preventing movement of upper portion 312 relative to lower tube 314, and engaging a locked extended position for the operator handles.

In one or more disclosed embodiments, cross-member 300 can include a switch 340. Switch 340 can be configured to generate a termination signal that disables a prime mover or other motor, engine, or the like (e.g., source 106 of walk-behind mower 100 shown in FIG. 1, supra). In response to actuation of release 118 and rotation of rotating disk₂ 320, a crest 324 of rotating disk₂ 320 depresses a switch actuator 342 of switch 340. Switch 340 generates and can continue to generate the termination signal in response to depression of switch actuator 342. When upper portion 312 is returned to a fully extended position, rotating disk₂ 320 can return to an original orientation that disengages crest 324 from switch actuator 342, which causes switch 340 to stop generating the termination signal. Thus, when operator handles are in the fully extended position, switch 340 does not deactivate a prime mover of an associated walk-behind mow device.

FIG. 3A depicts an example cross-member 300A for disclosed operator handles in a fully extended and locked position. Cross-member 300A shows lower rod 332 in a default or original position consistent with a force provided by the mechanical bias of disk₂ spring 322. The original position of lower rod 332 includes a lower rod locking tip 332A extended through an opening 314A in lower tube 314 and extended through an opening 312A in upper portion 312. By extending through both openings 312A, 314A lower rod 332 in its original position can mitigate or prevent movement of upper portion 312 relative lower tube 314, effectively locking the operator handles in the fully extended and locked position. In one or more disclosed aspects, an opposite side of cross-member 300A can include another lower rod, such as lower rod 333 of FIG. 3, which can likewise have a locking tip that extends into a second opening in the upper portion and a second opening in the lower tube to further mitigate or prevent movement of the upper portion of the operator handles relative the lower tube. When opening 312A in upper portion 312 is dis-aligned with opening 314A in lower tube 314, an exterior surface of upper portion 312 restricts lower rod 332 from returning to its original position despite the return bias provided by disk₂ spring 322 and rotating disk₂ 320.

In further aspects of the disclosed embodiments, cross-member 300A can include an upper rod 334. Upper rod 334 can be seated in a second opening in lower tube 314B, as illustrated. In the event that upper portion 312 is aligned with lower tube 314 such that a second opening in upper portion 312 aligns with second opening in lower tube 314B, upper rod 334 can be moved into both second openings (e.g., by an upper rod bias 834; see FIG. 8, infra) to lock the operator handles in another position that corresponds with alignment of the second openings. In one or more embodiments, this other position of the operator handles can be a fully compressed position, in which upper rod 334 facilitates a locked compressed position (e.g., see FIGS. 8 and 9, infra). Note that where the second opening in upper portion 312 is dis-aligned with the second opening in the lower tube 314B an exterior surface of upper portion 312 restricts upper rod 334 from engaging with upper portion 312 or preventing upper portion 312 from moving relative lower tube 314.

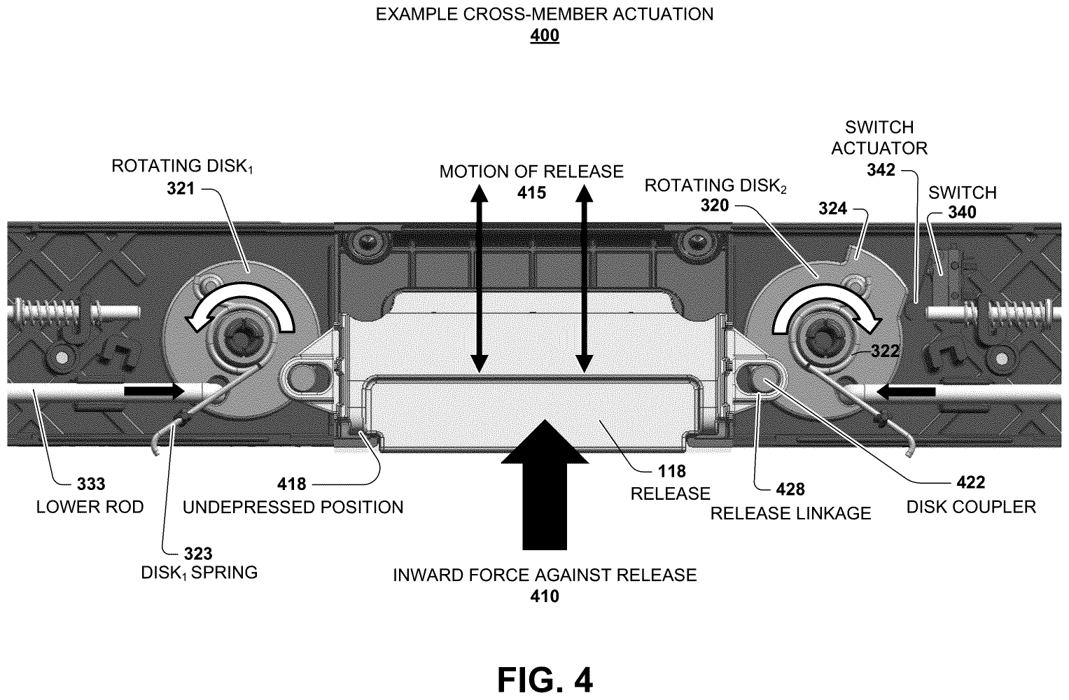

FIG. 4 illustrates an example actuation 400 of cross-member 300 according to one or more aspects of the disclosed embodiments. Illustrated is release 118 mechanically initially in an undepressed position 418, showing where release 118 can be seated with respect to cross-member body 302 prior to actuation of release 118. In addition, release 118 is shown mechanically coupled to rotating disk₂ 320 by way of a release linkage 428, and likewise can be mechanically coupled to rotating disk₁ 321 by way of a similar release linkage.

An inward force 410 against release 118 (e.g., supplied by an operator) that is greater than the mechanical force supplied by disk₁ spring 323 or disk₂ spring 322 (or both when supplied together in cross-member 300) can move release 118 inward within cross-member body 302 as shown by the arrows labeled motion of release 415. This inward movement of release 118 inward causes rotation of rotating disk₂ 320 clockwise to a first (clockwise) rotated position, and rotation of rotating disk₁ 321 counter-clockwise to a first (counter-clockwise) rotated position, as indicated by the solid arrows. Moreover, rotation of rotating disk₂ 320 pulls lower rod 332 inward (in the direction of the arrow over lower rod 332) and serves to remove lower rod locking tip 332A from opening in upper portion 312A (referring to FIG. 3A, supra). Similarly, rotation of disk₁ 321 pulls lower rod 333 inward (in the direction of the arrow over lower rod 333) and serves to remove a lower rod locking tip of lower rod 333 from a second opening in upper portion 312A adjacent lower rod 333.

Following inward movement of lower rods 332, 333 an upper portion of operator handles is then free to move relative a lower tube, as described herein. If the upper portion is then moved such that the openings in the upper rod are dis-aligned with openings in the lower tube through which the locking tips of lower rods 332, 333 are seated, then the exterior surface of the upper rod will prevent disk₂ spring 322 and disk₁ spring 323 from returning lower rods 332, 333 from their inward positions. With different words: the dis-alignment of the holes in the upper portion relative the lower tube locks lower rods 332, 333 in the inward position, and likewise maintains rotating disk₂ 320 and rotating disk₁ 321 in their first rotated positions. This in turn can lock release 118 into a first inward release position.

In response to subsequent re-alignment of the openings in the upper portion with the openings in the lower tube through which the locking tips of lower rods 332, 333 are seated, mechanical bias provided by disk₁ spring 323 and disk₂ spring 322 can reverse rotation of rotating disk₁ 321 and rotating disk₂ 320, respectively, thereby pushing lower rods 332, 333 outward through the newly re-aligned openings in both the lower tube and the upper portion. This can re-lock the upper portion relative to the lower tube and restore release 118 to the undepressed position 418.

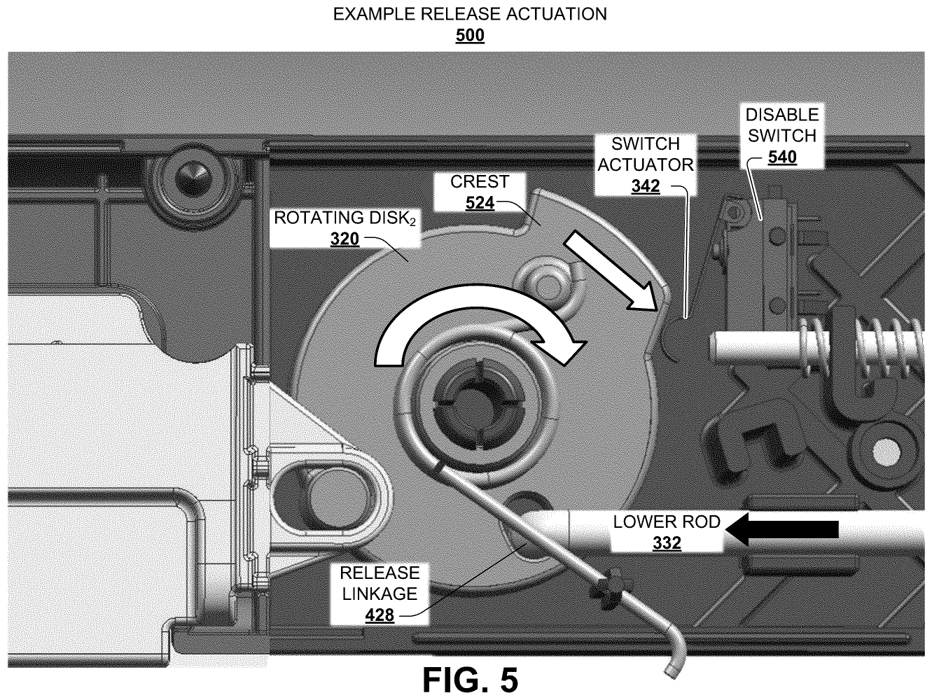

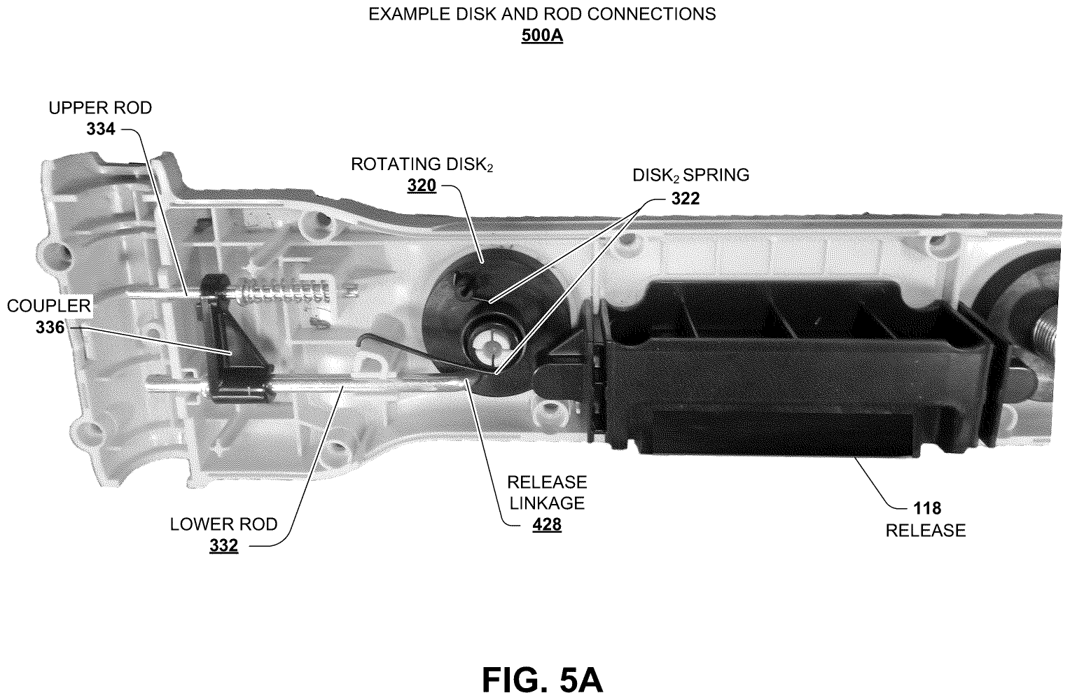

FIG. 5 depicts a close-up release actuation 500 and operation of release 118 in further aspects of the present disclosure. In response to inward force 410 against release 118 as described with respect to FIG. 4, supra, clockwise rotation of rotating disk₂ 320 causes a crest 524 on rotating disk₂ 320 to depress switch actuator 342 and activate a disable switch 540. Disable switch 540 generates a termination signal in response to actuation of switch actuator 342. Where the termination signal is applied to a prime mover on a maintenance apparatus, the termination signal can disable activation or operation of the prime mover while the termination signal is generated by disable switch 540. In response to re-alignment of the openings in the upper portion and lower tube that facilitates reverse rotation of rotating disk₂ 320 and restoration of release 118 to undepressed position 418, crest 524 disengages switch actuator 342, and disable switch 540 stops generating the termination signal. As a result, the prime mover of the associated maintenance apparatus is no longer prevented from activation/operation by disable switch 540 (though a second OPC circuit could still disable the prime mover in some embodiments, such as a second OPC circuit connected to OPC bail 122 of FIG. 1, supra).

FIG. 5A shows an image of an interior of a disclosed cross-member for handles of a maintenance apparatus in one or more embodiments. The interior image includes example disk and rod connections 500A responsive to movement of release 118. For instance, movement of release 118 upward within a housing of the cross-member (see, e.g., cross-member body 302 of FIG. 3, supra) causes counter-clockwise rotation of rotating disk₂ 320 and lateral movement of lower rod 332 inward toward a center of the cross-member. This inward movement of lower rod 332 causes coupler 336 to move inward along upper rod 334 to engage a flange thereof (e.g., see upper rod flange 636). Conversely, movement of release 118 downward within the housing causes clockwise rotation of rotating disk₂ 320 and outward lateral movement of lower rod 332 (and coupler 336).

FIG. 6 depicts an example base and mount 600 for operator handles of a maintenance apparatus according to further aspects of the disclosed embodiments. Base and mount 600 includes a handle-frame mount 220 and a base support 610. Handle-frame mount 220 includes frame/support mount(s) 620 facilitating fastening or securing base and mount 600 to a frame, structural support or other suitable structure of a walk-behind maintenance apparatus (e.g., see FIG. 1, supra). Base support 610 can be secured to a hollow lower portion 214 of the operator handles by a pivot fastener 226. Pivot fastener 226 enables a base 222 of hollow lower portion 214 to rotate between a base stop for extended position 224 and a base stop for folded position 228. In at least some embodiments, pivot fastener 226 can also secure base support 610 to handle-frame mount 220. In other embodiments, base support 610 can be secured to handle-frame mount 220 by another mechanism, or can be integrally formed with handle-frame mount 220.

In various aspects of disclosed embodiments, a latch 622 can be positioned within base 222 of hollow lower portion 214. Latch 622 can be configured to slide within hollow lower portion 214 and is secured from falling out of hollow lower portion 214 by a latch bias 624. Latch bias 624 can be secured at one end to pivot fastener 226 (or to base support 610 or handle-frame mount 220 near pivot fastener 226) and at a second end to latch 622 and provide a mechanical bias on latch 622 inward into hollow lower portion 214. In various embodiments, latch 622 can operate to secure base 222 of the operator handles to base support 610 and prevent rotation of base 222 away from base stop for extended position 224 to provide a locked extended position for the operator handles. In further embodiments, latch 622 can operate to secure base 222 of the operator handles to base support 610 near base stop for folded position 228 to prevent rotation of base 222 away from base stop for folded position 228, providing a locked folded position for the operator handles. In some aspects of disclosed embodiments, latch 622 can operate to secure base 222 near both the base stop for folded position 228 and near the base stop for extended position 224 to provide both the locked extended position and the locked folded position.

In addition to the foregoing, in the locked folded position a base seating pin 630 is provided for additional structural support for the operator handles. For instance, when in the locked folded position, a lower opening in hollow lower portion 214 and a lower slot opening in an upper portion of the operator handles can rest on base seating pin 630. Base seating pin 630 can prevent movement of the upper portion relative to hollow lower portion 214 when operator handles are in the locked folded position, providing secure structural support for the locked folded position. As a result, a maintenance apparatus can be suspended to a wall or other surface by the operator handles in the locked folded position as base seating pin 630 (along with an upper rod 334 in cross-member 300; see FIG. 3A, supra and FIG. 8, infra) can provide sufficient structural support to secure the operator handles while the weight of the maintenance apparatus is suspended from the operator handles.

FIG. 7 depicts a latch release in extended position 700 of a disclosed handle-frame mount 220, according to embodiments of the present disclosure. FIG. 7 shows latch 622 including a latch seat 728 within hollow lower portion 214 of the operator handles. An upper portion 212 of the operator handles within the hollow lower portion 214 can engage the latch seat 728 when pressed downward into hollow lower portion 214. In response to upper portion 212 being pressed downward within hollow lower portion 214, force 730 on latch seat 728 pushes latch 622 out from a base 222 of hollow lower portion 214 against latch bias 624. With upper portion 212 fully compressed as shown in FIG. 7A, latch 622 is shown disengaged 700A from a support catch 726 of base support 610, which locks latch 622 in a locked extended position. Once released from support catch 726, base 622 and operator handles are free to rotate out from the locked extended position as shown in FIG. 7A.

FIG. 7A is a perspective view of latch 622 showing a latch foot 722A that is released from base support 610 with latch 622 released from the locked extended position. Hollow lower portion 214 and upper portion 212 within hollow lower portion 214 are freed to rotate about pivot fastener 226. When approaching a base stop for folded position 628, latch foot 722A can engage a locking cam 730A as shown specifically in FIG. 7B. Locking cam 730A has a cam surface 730B that pushes latch foot 722A out from hollow lower portion 214 against latch bias 624 as hollow lower portion 214 is rotated along cam surface 730B to a fully folded position adjacent base stop for folded position 628. Movement of latch 622 outward away from pivot fastener 226 separates latch seat 728 from a bottom of upper portion base 712B, as shown. Where latch foot 722 fails to engage locking cam 730A a foot stop 732B can prevent rotation of hollow lower portion 214 into the fully folded position, to avoid latch 622 failing to be locked by locking cam 730A when in the fully folded position, as described below with respect to FIG. 7C.

When hollow lower portion 214 reaches the fully folded position, latch foot 722 clears cam surface 730B and latch bias 624 pulls latch 622 and latch seat 728 into contact with upper portion base 712B, as shown by FIG. 7C. Moreover, latch foot 722 becomes secured behind a back surface of locking cam 730A when latch seat 728 is pulled into contact with upper portion base 712B. With latch foot 722 secured behind the back surface of locking cam 730A, lower hollow portion 214 is locked in the folded position as locking cam 730 prevents latch 622 and lower hollow portion 214 from rotating out of the folded position.

In addition to the foregoing, with hollow lower portion 214 in the locked folded position an opening 712C in hollow lower portion 214 can rest upon a base seating pin 630 of base support 610. Additionally, a slot 714C in upper portion 212 can align with opening 712C in hollow lower portion 214 when upper portion 212 is in a compressed position relative to hollow lower portion 214 (e.g., a locked compressed position or fully compressed position, or substantially the same). Therefore, when slot 714C is aligned with opening 712C base seating pin 630 can engage both opening 712C and slot 714C. In an embodiment(s), opening 712C can be conformal to or substantially conformal to base seating pin 630 and can sit over base seating pin 630. Slot 714C in upper portion 212 defines a length over which slot 714C can sit over and around base seating pin 630, allowing upper portion 212 to slide a distance relative to hollow lower portion 214. When upper portion 212 is in the (fully) compressed position relative to hollow lower portion 214 (e.g., see FIGS. 2A and 7A, supra) base seating pin 630 is situated at an upper end of slot 714C (left-most side of slot 714C as depicted in FIG. 7C). With latch foot 722 secured behind locking cam 730A and hollow lower portion 214 locked in the folded position, opening 712C and slot 714C engage with base seating pin 630. This allows operator handles including upper portion 212 and hollow lower portion 214 to be suspended from an operator handgrip 120 and cause a weight of an attached maintenance apparatus (e.g., walk-behind mower 100) to be supported at least in part by base seating pin 630.

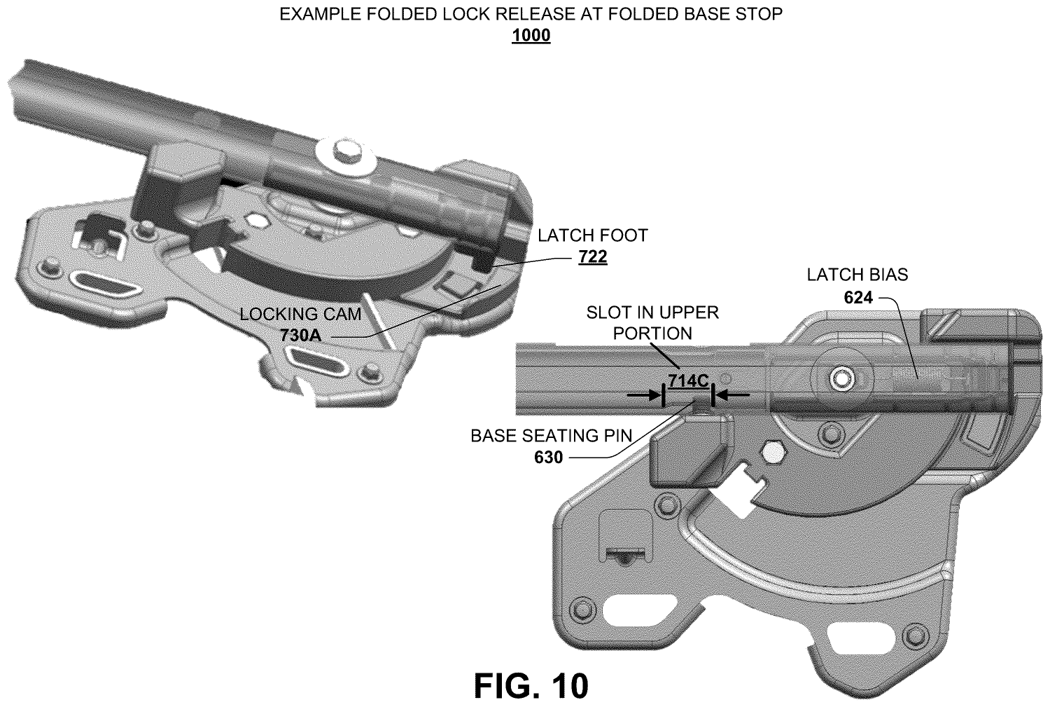

When upper portion 212 is locked in the (locked) fully compressed position slot 714C engages base seating pin 630 at a left-most extent thereof (as shown in FIG. 7C and introduced above). In response to upper portion 212 becoming unlocked relative to hollow lower portion 214, upper portion 212 can move as allowed by the length of slot 714C and width of base seating pin 630. Moreover, latch bias 624 can apply a force upon latch 622 that pushes upper portion base 712B away from pivot fastener 226 as allowed by slot 714C and base seating pin 630. In various embodiments, the length of slot 714C can be selected to allow latch 622 enough movement for latch foot 722 to clear locking cam 730A (e.g., see FIG. 10, infra) when upper portion 212 is unlocked from the compressed position. As a result, hollow lower portion 214 can be unlocked from the locked folded position in response to upper portion 212 being unlocked from the locked compressed position. The operator handles are then free to move between the folded position and the extended position; moreover, rotating the operator handles away from the folded position dis-engages opening 712C in hollow lower portion 214 and slot 714C in upper portion 212 from base seating pin 630. The upper portion 212 of the operator handles can then move freely relative to hollow lower portion 214.

FIG. 8 depicts an example interior of a cross-member 800 for operator handles of a maintenance apparatus in a locked compressed position, according to various aspects of the present disclosure. In various embodiments, cross-member 800 can be substantially similar to cross-member 300 of FIG. 3. However, the subject disclosure is not so limited, as cross-member 800 can differ from cross-member 300 in some or more embodiments.

Cross-member 800 can include a lower rod 332 that is removed from an upper portion 312 of an operator handle by release linkage 428 that physically couples lower rod 332 to a rotatable disk, as described herein. Cross-member 334 also includes an upper rod 334 having one end inserted through an opening in a lower tube 314 and a second opening 816 in upper portion 312 that is aligned with the opening in lower tube 314. Upper rod 334 is coupled to an upper rod bias 834 that provides a mechanical bias on an upper rod flange 636 in a direction of second opening 816 in upper portion 312, as shown by the solid arrow. In response to actuation of a release 818 from a first actuated position further into (upward as shown in FIG. 8) a cross-member body of cross-member 800 to a second actuated position (e.g., see FIG. 9), lower rod 332 is pulled further into cross-member 800 and a flange 338 of lower rod 332 pushes against a coupler 336 secured to lower rod 332 leftward as shown in FIG. 8. The coupler 336 slides over upper rod 334 and engages upper rod flange 636, pushing upper rod 334 inward (leftward) against the mechanical bias of upper rod bias 834. As a result, the end of upper rod 334 is removed from second opening 816 in upper portion 312, allowing upper portion 312 to move relative to lower tube 314.

FIG. 9 shows upper rod 334 pushed inward in the direction of the arrow in a fully removed position 934 from second opening 816 in upper portion 312, in response to release 818 being actuated to a fully depressed position 918. As stated previously, with upper rod 334 removed from second opening 816, upper portion 312 can move relative lower tube 314. Where a base 622 of lower tube 314 is in a locked folded position as shown in FIG. 7C, movement of upper portion 312 in response to release 818 being actuated to fully depressed position 918 is limited by the length of slot 714C and dimensions of base seating pin 630. However, as noted above these dimensions can be sufficient for latch foot 722 to clear locking cam 730A (see FIG. 10, infra), allowing lower tube 314 to be rotated out of the folded position removing upper portion 312 and lower tube 314 from engagement with base seating pin 630. Thus, in response to release 818 being actuated to fully depressed position 918 and rotation of the operator handles away from the folded position upper portion 312 can be moved freely relative lower tube 314, between a fully extended position and the fully compressed position as described throughout this specification.

FIG. 9A depicts example collapsible handles 910A for a HE turf maintenance apparatus according to one or more aspects of the present disclosure. Collapsible handles 910A are positioned at respective ends of cross-member 116, with upper portion 112 movable into and out from lower portion 114. Additionally, collapsible handles 910A define a plurality of locked extended positions. As illustrated in FIG. 9A, collapsible handles 910A are positioned in a first locked extended position in which an upper and lower rod of cross-member 116 are positioned within second opening in upper portion 816 and opening in upper portion 312A, respectively. The first locked extended position provides a first length for collapsible handles 910A. A set of additional holes in upper portion 912A are provided, spaced apart by a distance 920A equal to the distance between the upper rod and lower rod of cross-member 116. When upper portion 112 is moved with respect to lower portion 114 such that additional holes 912A are aligned with the upper and lower rod of cross-member 116, collapsible handles 910A are in a second locked extended position having a second length. Other sets of additional holes (not depicted) in upper portion 112 can define other locked extended positions have other respective lengths (e.g., a third locked extended position defining a third length for collapsible handles 910A, a fourth locked extended position defining a fourth length for collapsible handles 910A, and so forth).

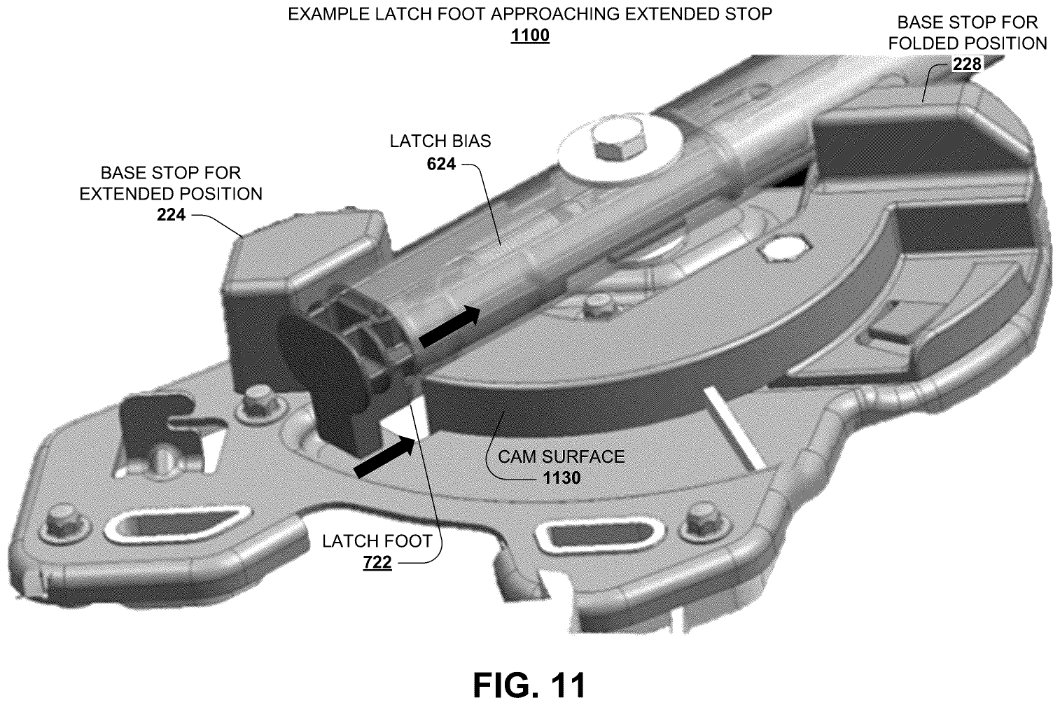

As shown in FIG. 10, when upper rod 334 is removed from second opening 816 in upper portion 312, upper portion base 712B can be pushed by latch seat 728 and latch bias 624 so that a right-most edge of slot 714C in upper portion 312 abuts base seating pin 630, as shown in FIG. 10. Concurrently, latch foot 722 moves inward of locking cam 730A, and lower tube 314 is no longer prevented by locking cam 730 from rotating about pivot fastener 226. As shown in FIG. 11, latch foot 722 can follow a cam surface 1130 of base support 610 as lower tube 314 rotates between base stop for folded position 228 and base stop for extended position 224. Cam surface 1130 can be shaped to cause latch foot 722 to be pulled out from lower tube 314 against latch bias 624 as lower tube 314 rotates closer to base stop for extended position 224. This causes an opening in latch 622 to separate from support catch 726 in base support 610. When latch foot 722 fully clears cam surface 1130 upon lower tube reaching or substantially reaching base stop for extended position 224 as shown in FIG. 11, latch bias 624 pulls latch 622 inward into lower tube 314 as shown by the solid arrows, causing the opening in latch 622 to engage support catch 726 as shown in FIG. 7, supra. This effectively locks latch 622 and lower tube 314 in the locked extended position, as described throughout this specification.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein. As an example, an arrangement of components depicted in one embodiment can be swapped with components depicted in another embodiment, optionally excluding some components or including other components illustrated in a third embodiment, according to design creativity of one of ordinary skill in the art. For instance, collapsible handles 110 of FIG. 1 can be arranged together with upper portion 312 and lower tube 314 of FIG. 3, and optionally cross-member 800 of FIG. 8, as suitable. As another example, frame/support mount(s) 620 of FIG. 6 can be integrated with handle-frame mounts 220 of FIG. 2 to secure collapsible handles 110 to mow deck 108 of FIG. 1. As a further example, components of disclosed devices can be implemented as connected to other components rather than included within the parent device. For instance, switch 340 can be implemented at least in part within upper portion 312 of collapsible handles 110 or lower tube 314 of collapsible handles 110, such as where lower rod 332 (or upper rod 334) engages switch actuator 342 within upper portion 312 or lower tube 314, or in another implementation switch 340 can be implemented at least in part within operator handgrip 120 or OPC bail 122, or a second switching 340 can be implemented within operator handgrip 120, OPC bail 122 or at frame-mount 220 or power source 106, etc., together with switch 340 implemented within cross-member 300 as shown (or implemented in upper portion 312 or lower tube 314 as described above). Alternatively, the opposite orientation can be implemented within the scope of the disclosure: one component (e.g., lower rod 332) depicted separate from another component (e.g., upper rod 334) can be aggregated as a single component in some embodiments (e.g., lower rod 332 and upper rod 334 are a single unit that extend different lengths into aligned openings in upper portion 312 and lower tube 314 to implement a locked compressed position of operator handles 110, a locked extended portion of operator handles 110 or both, or other suitable aggregation of disclosed elements). Additionally, it is noted that one or more disclosed processes can be combined into a single process providing aggregate functionality. Still further, components of disclosed machines/devices/sensors/control units can also interact with one or more other components not specifically described herein but known by those of skill in the art.

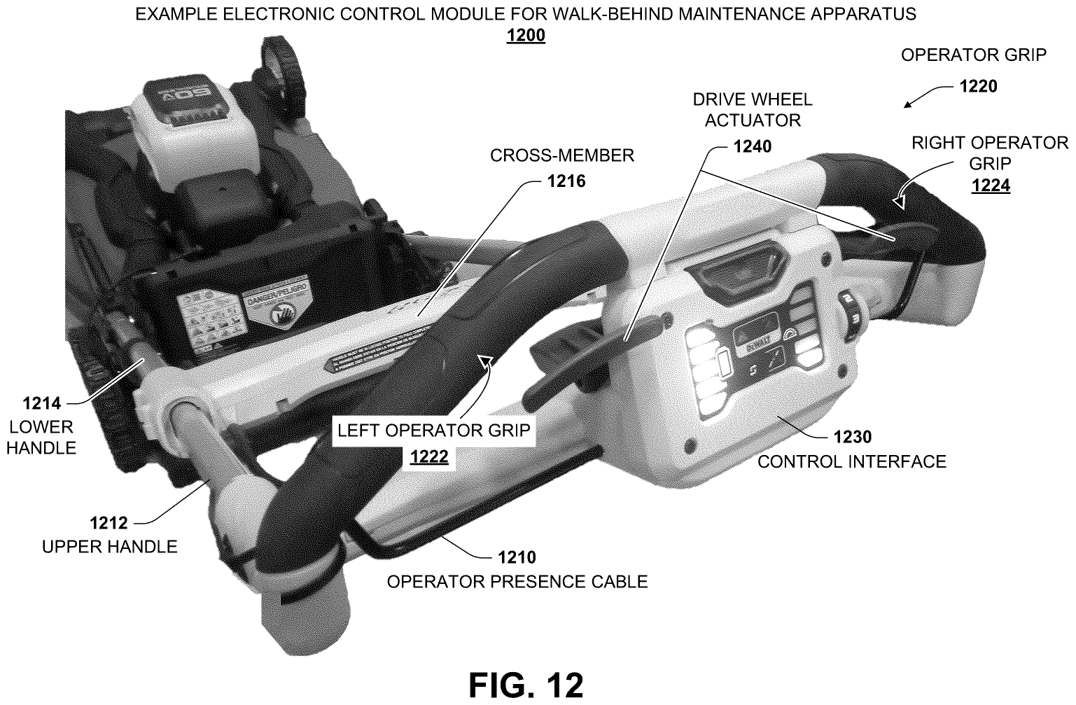

FIG. 12 illustrates an image of an electronic control module 1200 for a walk-behind maintenance apparatus according to one or more embodiments of the present disclosure. Electronic control module 1200 can be configured to operate electronic and electro-mechanical functions and programming of the walk-behind maintenance apparatus. Electronic control module 1200 can include a control interface 1230, and an operator presence cable 1210. Additionally, electronic control module 1200 can include one or more drive wheel actuators 1240 in at least some embodiments of the present disclosure.

The walk-behind maintenance apparatus includes an operator handle having an upper handle 1212, a lower handle 1214 and a cross-member 1216 situated between the upper handle 1212 and lower handle 1214. Control interface 1230 of electronic control module 1200 can be secured to an operator grip 1220 at an end of upper handle 1212. Operator presence cable 1210 can have a default position that is mechanically biased away from operator grip 1220, and a non-default position in which a cross member of operator presence cable 1210 is adjacent to operator grip 1220 against the mechanical bias.

In some embodiments, operation of control interface 1230 can wholly or in part depend upon actuation of operator presence cable 1210. As one example, operator presence cable 1210 can operate as a switch for supplying or disconnecting electrical power to control interface 1230. In this example, when detected in the non-default position (e.g., as moved by an operator), electrical power from a battery or other power supply can be supplied to control interface 1230 allowing control interface 1230 to be turned on. When the operator presence cable 1210 is moved to the non-default position, power to control interface 1230 can be shut off in this example implementation, stopping operation of electrical and electro-mechanical functions of control interface 1230. In an alternate example, operator presence cable 1210 can operate as a switch enabling and disabling electro-mechanical power from control interface 1230 to be distributed to one or more mechanical functions of a walk-behind maintenance apparatus, such as a cutting motor, a wheel drive motor, or the like, or a combination of the foregoing. In the latter example, control interface 1230 can be powered on and off independently of operator presence cable 1210 but at least a subset of electro-mechanical functions of control interface 1230 are electrically powered in response to operator presence cable 1210 being detected in the non-default position, and are electrically deactivated in response to operator presence cable 1210 being detected in the default position. Other example implementations in which operator presence cable 1210 affects operation of control interface 1230 of some or all functions of control interface 1230 known in the art or reasonably conveyed to one of ordinary skill in the art by way of the context provided herein are within the scope of the present disclosure.

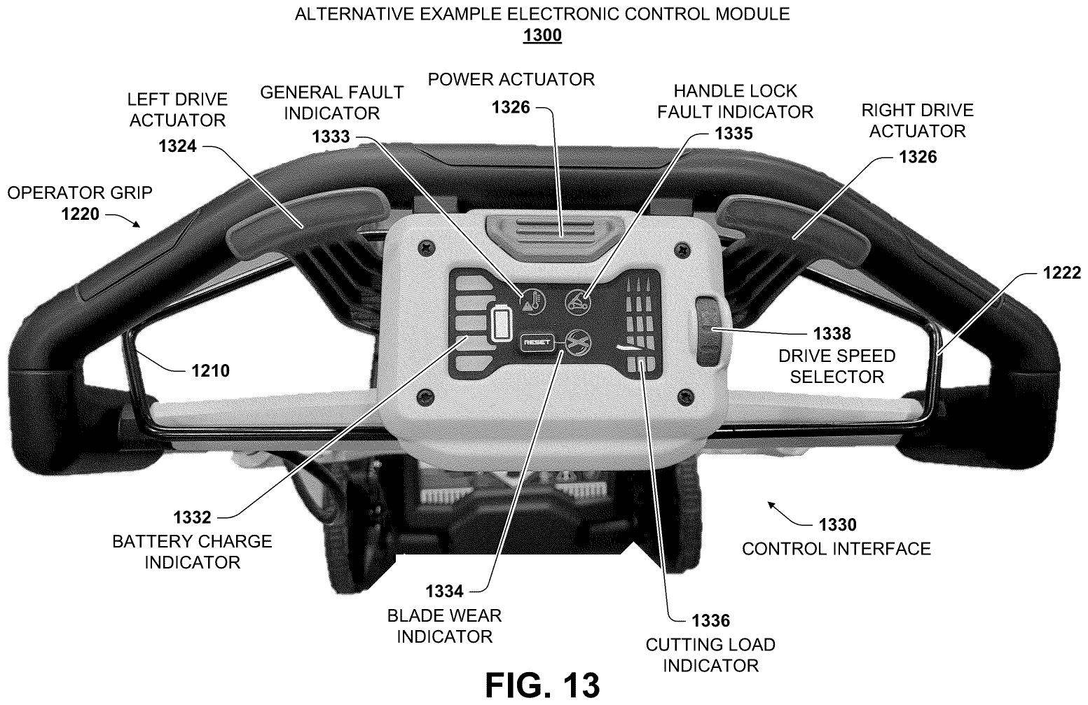

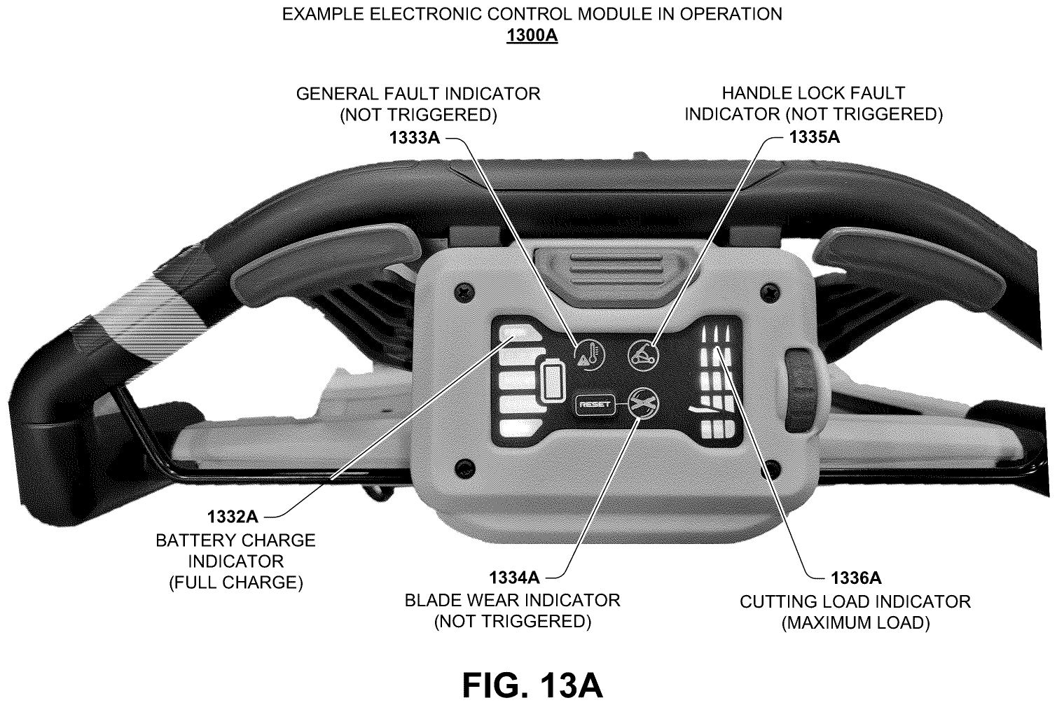

FIG. 13 illustrates an alternative electronic control module 1300 according to additional embodiments of the present disclosure. Electronic control module 1300 includes a control interface 1330 secured to an operator grip 1220 of a maintenance apparatus. An operator presence cable 1210 can be configured to operate in conjunction with electronic control module 1300 to conditionally activate (and deactivate) one or more electrical or electro-mechanical functions of the maintenance apparatus in various embodiments. A power actuator 1326 of control interface 1330 provides electrical power to control interface 1330 (optionally when operator presence cable 1210 is detected in a non-default position). Various operator output indicators and operator inputs become operable in response to control interface 1330 powering on in response to activation of power actuator 1326 (e.g., see FIG. 13A, infra).

Once powered on, a left drive actuator 1324 and right drive actuator 1326 are provided enabling an operator to provide power to drive wheels of the maintenance apparatus upon depressing left drive actuator 1324 or right drive actuator 1326 (or both), in at least some embodiments. A drive speed selector 1338 can control a drive speed of the drive wheels when activated by the drive actuator(s). Note that left drive actuator 1324 and right drive actuator 1326 are embodied as thumb controllers, in that they are positioned proximate an operator's left and right thumbs, respectively, when the operators hands grip left and right portions of operator grip 1220 as shown at left operator grip 1222 and right operator grip 1224 (with control interface 1230 and respective drive wheel actuators 1240 positioned there between). Other positions or orientations of left drive actuator 1324 and right drive actuator 1326 relative to an operator's hands, thumbs, fingers, etc. are within the scope of the present disclosure. In other embodiments without powered drive wheels, left drive actuator 1324, right drive actuator 1326 and drive speed selector 1338 can be absent.

Control interface 1330 includes a battery charge indicator 1332 showing a current charge on a battery supply of the maintenance apparatus, and a cutting load indicator 1336 showing current physical resistance measured at the cutting system of the maintenance apparatus. Cutting load indicator 1336 allows an operator to adjust a cutting height of the maintenance apparatus to reduce or increase load to a desired load level. Since cutting load has a significant impact on power consumption and battery life, cutting load indicator 1336 gives an operator real-time feedback suitable to enhance battery longevity.

In addition to the foregoing, control interface 1330 can include a blade wear indicator 1334 that activates in response to a metric of blade wear reaching a threshold level. The metric of blade wear can include a number of hours of operation, a number(s) of hours within a range(s) of cutting load level, or the like, or a suitable combination of the foregoing. Once the threshold level is reached blade wear indicator 1334 can light up, or otherwise activate as a recommendation to have maintenance performed on a cutting system (e.g., blade(s) sharpened, blade(s) replaced, or the like).

A handle lock fault indicator 1335 can be provided to be activated when a collapsible handle is not in a locked extended position (e.g., see FIGS. 1, 2 and 9A, supra). In addition, handle lock fault indicator 1335 can be coupled with a disabling switch that disables electro-mechanical functions of the maintenance apparatus, such as powering of a cutting system motor, powering of drive wheels, and the like, in response to handle lock fault indicator 1335 being activated. A general fault indicator 1333 can be provided to activate in response to an electrical, environmental or mechanical error associated with the maintenance apparatus. Examples of such errors can include: lower battery power; improper positioning of battery; faulty power wire or communication wire connection; an excessive load on the cutting system, an error condition of a cutting system motor, a temperature error (e.g., overheating), or the like, or a suitable combination of the foregoing.

FIG. 13A illustrates an example of an electronic control module 1300A in operation. Electronic control module 1300A shows a battery charge indicator 1332A at full charge. Illumination of fewer number of charge levels represents a battery charge of less than full charge. A cutting load indicator 1336A at maximum cutting load is also shown, with fewer illuminated load levels indicating less than maximum cutting load measured at a cutting system. Handle lock fault indicator 1335A shows an example of non-activation, as does general fault indicator 1333A and blade wear indicator 1334A.

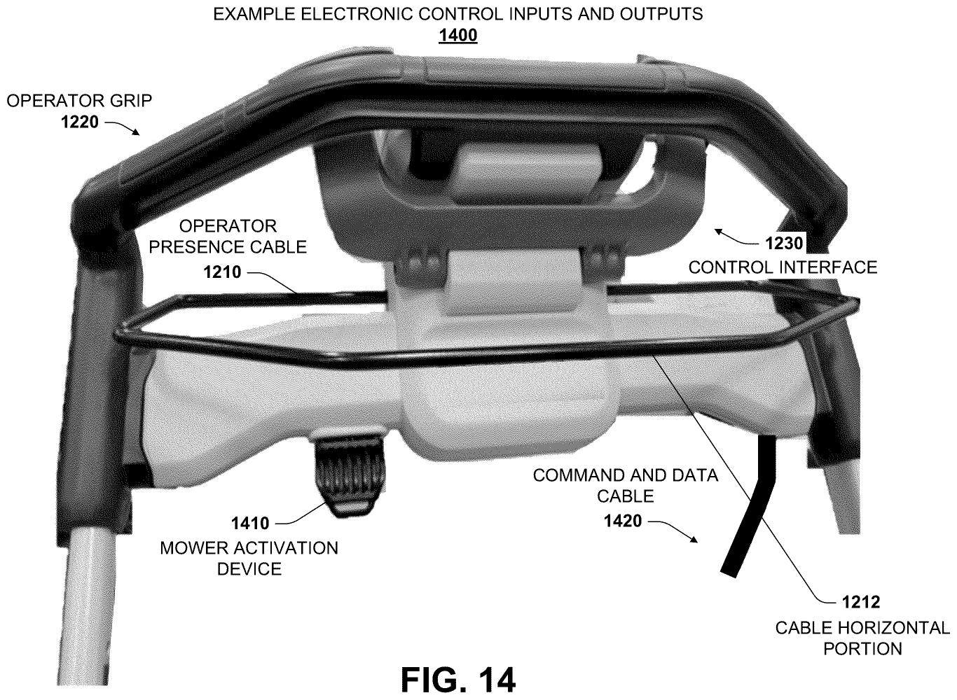

FIG. 14 depicts an example front view 1400 of electronic control inputs and outputs for a maintenance apparatus according to further disclosed embodiments. Front view 1400 depicts a front of operator grip 1220 and a rear side of control interface 1230. A rear view of operator presence cable 1210 is also shown in its default position with cable horizontal portion 1212 separated physically from operator grip 1220. In a non-default position (not depicted), cable horizontal portion 1212 can be rotated to be physically adjacent to operator grip 1220 to implement functions described herein. Further to the above, a mower activation device 1410 can be provided as an optional condition to powering on the maintenance apparatus and control interface 1230. Absence of mower activation device 1410 can prevent powering on of control interface 1230 (and the maintenance apparatus), whereas proper positioning of mower activation device 1410 in its receptacle can satisfy one condition for powering on the control interface 1230 (in conjunction with detecting operator presence cable 1210 in a non-default position, absence of a fault associated with general fault indictor 1333 and absence of a fault associated with handle lock fault indicator 1335, and so forth).

A command and data cable 1420 can provide electrical power to control interface 1230, and optionally a receptacle of mower activation device 1410, and can convey signals between control interface 1230 and other portions of the maintenance apparatus. In at least some embodiments, electrical power to control interface 1230 can be conveyed by cable 1420, whereas command and data control signals can be conveyed by a wireless communication between control interface 1230 and one or more electronic sensors or electronic motors of the maintenance apparatus. Suitable electronic sensors coupled to command and data cable 1420 (or through the wireless communication) can include, e.g., switch 340, disable switch 540, or a switch (not depicted) associated with detecting latch foot 722 secured by locking cam 730A, or yet another switch (not depicted) associated with detecting latch foot 722 secured behind cam surface 1130. Suitable electronic motors can include a prime mover (e.g., source 106 of walk-behind mower 100 of FIG. 1, supra) or a wheel motor for driving front or rear wheels of the maintenance apparatus (e.g., front wheels 104; rear wheels 102). In at least some embodiments, command and data cable 1420 (or the wireless communication) can convey the termination signal generated by switch 340 or disable switch 540 to control interface 1230, which in turn triggers termination of the electronic motor(s) (e.g., prime mover; drive wheels, etc.) also by way of command and data cable 1420 (or a second wireless communication).

As utilized herein, relative terms and terms of degree including the term “about”, “approximately”, “substantially”, “roughly”, “near” and others are intended to incorporate ranges and variations about a qualified term reasonably encountered by one of ordinary skill in the art in fabricating, compiling or optimizing the embodiments disclosed herein to suit design preferences, where not explicitly specified otherwise. When utilized to modify a numerical description of a disclosed element, a relative term can imply a suitable range about the given number. Any implied range is intended to be consistent with and achieve the same or similar functions as described for the disclosed structure given the numerical description, where applicable. Where such ranges are not explicitly disclosed, a range within typical manufacturing tolerances associated with suitable manufacturing equipment (e.g., injection molding equipment, extrusion equipment, metal stamping equipment, and so forth) understood by one of ordinary skill in the art for realizing an element from a disclosed illustration or description can be implied. In some embodiments, depending on context and the capabilities of one of ordinary skill in the art, relative terminology can refer to a variation in a disclosed value or characteristic; e.g., a zero to five-percent variance or a zero to ten-percent variance from precise mathematically defined value or characteristic, or any suitable value or range there between can define a scope for a disclosed term of degree. As an example, a disclosed mechanical dimension can have a variance of suitable manufacturing tolerances as would be understood by one of ordinary skill in the art, or a variance of a few percent about the disclosed mechanical dimension that would achieve a stated purpose or function of the disclosed mechanical dimension. Relative terms utilized for qualitative (rather than quantitative) description can be understood to imply explicitly stated alternatives or variations, variations understood in the art to occur from manufacturing tolerances or variations in a manufacturing process, variations understood in the art to achieve the function or purpose described for a particular component or process, or a suitable combination of the foregoing.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A walk-behind grass mowing apparatus, comprising:
a mow deck formed within or secured to a support structure;
at least one front wheel and at least one rear wheel secured to the support structure;
a plurality of blades rotatably secured within the mow deck;
a power source secured to the support structure that, when activated, provides mechanical force to the plurality of blades; and
an operator handle secured to the support structure and having an extended position and a folded position, wherein the operator handle further comprises:
an upper portion,
a lower portion,
a cross-member extending between left and right segments of the upper portion or the lower portion, and
a mount structure that secures the operator handle to the support structure,
wherein:
the upper portion is movable along the lower portion between a fully extended position and a compressed position,
the cross-member includes a locking mechanism that locks the upper portion from moving along the lower portion in at least one of: the fully extended position or the compressed position, and
the cross-member includes a release that unlocks the locking mechanism and permits movement of the upper portion along the lower portion between the fully extended position and the compressed position.

2. The walk-behind grass mowing apparatus of claim 1, wherein the locking mechanism locks the upper portion from moving along the lower portion in both the fully extended position and the compressed position.

3. The walk-behind grass mowing apparatus of claim 1, wherein the release comprises a single operator actuator that unlocks the locking mechanism from the fully extended position or from the compressed position.

4. The walk-behind grass mowing apparatus of claim 1, wherein the operator handle in the extended position is configured to move between the fully extended position and the compressed position when unlocked from the locking mechanism.

5. The walk-behind grass mowing apparatus of claim 1, wherein the mount structure includes a pivot device that secures the lower portion to the mount structure and facilitates movement of the lower portion between the extended position and the folded position.

6. The walk-behind grass mowing apparatus of claim 5, wherein the mount structure is operable to lock the lower portion into a locked extended position and prevent rotation of the lower portion from the locked extended position when locked.

7. The walk-behind grass mowing apparatus of claim 6, further comprising: a locking tab within the mount structure located near a base of the lower portion when rotated into the extended position and a mechanically biased latch within the base of the lower portion that secures to the locking tab to effect locking the lower portion into the locked extended position.

8. The walk-behind grass mowing apparatus of claim 7, wherein in response the upper portion of the operator handle being put into the compressed position with respect to the lower portion, a base of the upper portion releases the mechanically biased latch from the locking tab, and unlocks the lower portion from the locked extended position.

9. The walk-behind grass mowing apparatus of claim 5, wherein the mount structure is operable to:
lock the lower portion into the folded position resulting in a locked folded position; and
prevent movement of the lower portion out of the folded position when the lower portion is locked into the locked folded position.

10. The walk-behind grass mowing apparatus of claim 9, wherein the mount structure further comprising:
a locking cam located near a base of the lower portion when rotated toward the folded position; and
a mechanically biased latch within the base of the lower portion having a latch foot that couples to the locking cam and secures the lower portion into the locked folded position when the lower portion is fully moved into the folded position.

11. The walk-behind grass mowing apparatus of claim 10, wherein in response to actuation of the release at the cross-member the latch foot of the mechanically biased latch clears the locking cam freeing the lower portion from the locked folded position.

12. The walk-behind grass mowing apparatus of claim 11, wherein:
the mount structure further comprises a cam surface that engages the latch foot and extends the mechanically biased latch outward from the base of the lower portion against the mechanical bias as the lower portion is moved from the folded position to the extended position;
the cam surface ends before the lower portion reaches the extended position;
the latch foot clears an end of the cam surface when the lower portion reaches the extended position; and
in response to the latch foot clearing the end of the cam surface the mechanical bias pulls the mechanically biased latch into the base of the lower portion to engage a locking tab formed in the mount structure and lock the lower portion into the extended position.

13. The walk-behind grass mowing apparatus of claim 1, wherein the lower portion of the operator handle is at least in part hollow and the upper portion of the operator handle is movable along the lower portion by sliding within an interior of the lower portion.

14. The walk-behind grass mowing apparatus of claim 13, wherein:
the lower portion includes a first hollow structure and a second hollow structure secured to the mount structure at respective first ends thereof and connected to the cross-member at respective second ends thereof;
the cross-member extends between the first hollow structure and the second hollow structure of the lower portion; and
the locking mechanism includes a rod within the cross-member that engages with a hole in the first hollow structure of the lower portion and, when the upper portion is in the fully extended position, also engages with a second hole in the upper portion to lock the upper portion into the fully extended position.

15. The walk-behind grass mowing apparatus of claim 14, wherein the locking mechanism further comprises a second rod within the cross-member that engages with a third hole in the first hollow structure of the lower portion and, when the upper portion is in the compressed position, also engages with a fourth hole in the upper portion to lock the upper portion into the compressed position.

16. The walk-behind grass mowing apparatus of claim 15, wherein the cross-member includes a rotating disk with mechanical bias coupled to the release and coupled to the rod, wherein in response to the release being actuated to a first release position, the rotating disk pulls the rod out from the second hole in the upper portion, unlocking the upper portion from the fully extended position.

17. The walk-behind grass mowing apparatus of claim 16, further comprising a coupler secured between the rod and the second rod, and wherein in response to the release being actuated to a second release position, the rotating disk pulls the rod further out from the second hole and causes the coupler to pull the second rod out from the fourth hole in the upper portion, unlocking the upper portion from the compressed position.

18. The walk-behind grass mowing apparatus of claim 1, further comprising a switch located within the cross-member that disables the power source in response to activation of the switch.

19. The walk-behind grass mowing apparatus of claim 18, wherein the switch is activated in response to movement of the release to a first release position.

20. The walk-behind grass mowing apparatus of claim 1, wherein when the upper portion is moved to the compressed position along the lower portion, the operator handle is configured to rotate between the extended position and the folded position.

21. The walk-behind grass mowing apparatus of claim 1, wherein the fully extended position defines a plurality of lengths of the upper portion of the operator handle relative to the lower portion thereof, and wherein the locking mechanism of the cross-member locks the upper portion from moving along the lower portion in one of the plurality of lengths defined by the fully extended position.

22. An operator handle for a turf maintenance apparatus, comprising:
an upper handle portion comprising an operator grip;
a lower handle portion comprising a hollow tube within which the upper handle portion can move between a compressed position and an extended position;
a mount structure comprising one or more fastener supports for fixedly attaching the mount structure to an apparatus, wherein the lower handle portion is rotatably secured near a base thereof to the mount structure and is rotatable between an upright position and a folded position relative to the apparatus, and wherein the mount structure further comprises a first locking mechanism to lock the lower handle portion in at least one of: the upright position or the folded position preventing rotation of the lower handle portion when locked by the locking mechanism; and
a cross member positioned at an intersection of the upper handle portion and the lower handle portion and through which the upper handle portion engages the hollow tube of the lower handle portion, and the cross member further including a release configured to unlock the lower handle portion from the folded position.

23. The operator handle of claim 22, wherein the mount structure further comprises a second locking mechanism configured to lock the lower handle portion in a second of: the upright position or the folded position.

24. The operator handle of claim 23, further comprising a latch seated within the base of the lower handle portion, the latch having a mechanical bias pulling the latch into the lower handle portion and having a latch foot structure that stops movement of the latch into the lower handle portion in response to the mechanical bias pulling the latch foot structure into contact with a bottom edge of the lower handle portion.

25. The operator handle of claim 24, wherein the second locking mechanism includes a locking tab situated near the base of the lower handle portion when rotated into the upright position and wherein the latch further comprises a support catch, wherein in response to the mechanical bias pulling the latch into the lower handle portion when in the upright position the support catch engages the locking tab and prevents rotation of the lower handle portion out of the upright position.

26. The operator handle of claim 25, wherein the upper handle portion moved to the compressed position pushes the latch against the mechanical bias and releases the support catch from the locking tab, allowing the lower handle portion to rotate out of the upright position.

27. The operator handle of claim 24, wherein the second locking mechanism includes a locking cam structure situated near the base of the lower handle portion when rotated into the folded position, wherein the locking cam structure:
engages the latch foot structure as the lower handle portion is rotated to the folded position;
pulls the latch outward from the lower handle portion against the mechanical bias in response to the lower handle portion continuing to rotate to the folded position after the locking cam structure engages the latch foot structure; and
traps the latch foot structure to prevent rotation of the lower handle portion out of the folded position in response to the lower handle portion reaching the folded position.

28. The operator handle of claim 27, wherein activation of the release further:
unlocks the upper handle portion from the compressed position;
enables the mechanical bias to pull the latch clear of the locking cam structure; and
unlocks the lower handle portion from the folded position.

29. The operator handle of claim 22, wherein the cross member includes a second locking mechanism configured to lock the upper handle in at least one of: the compressed position or the extended position.

30. The operator handle of claim 29, wherein the release is further configured to unlock the upper handle from the compressed position.

31. The operator handle of claim 29, wherein the release is further configured to unlock the upper handle from the extended position.

32. The operator handle of claim 29, wherein the cross member includes a second locking mechanism configured to lock the upper handle in at least one of: the compressed position, the extended position, a second extended position or a third extended position.

33. A cross member for an operator handle of a turf maintenance apparatus, comprising:
a cross-member body having an exterior and an interior, wherein the interior engages with a first elongated structure of the operator handle at one end of the cross-member body and engages with a second elongated structure of the operator handle at a second end of the cross-member body;
a first locking structure seated within the interior of the cross-member body that engages an opening in a lower portion of the first elongated structure and also engages a second opening in an upper portion of the first elongated structure, in response to the second opening being aligned with the opening, to lock the upper portion of the first elongated structure in a fixed position relative the lower portion of the first elongated structure;
a mechanically biased release actuator seated within the interior and coupled to the first locking structure and operable to drive the first locking structure toward the one end of the cross-member body in response to the mechanical bias and engage both the opening and the second opening in response to the second opening being aligned with the opening; and
a release exposed to the exterior of the cross-member body and coupled to the mechanically biased release actuator such that, when activated to a first activation position, the release moves the mechanically biased release actuator against the mechanical bias and removes the first locking structure from the second opening and frees the upper portion of the first elongated structure to move relative to the lower portion of the first elongated structure.

34. The cross member of claim 33, further comprising a second locking structure seated within the interior of the cross-member body that engages a third opening in a lower portion of the second elongated structure and also engages a fourth opening in an upper portion of the second elongated structure, in response to the fourth opening being aligned with the third opening, to lock the upper portion of the second elongated structure in the fixed position relative the lower portion of the second elongated structure.

35. The cross member of claim 34, further comprising a second mechanically biased release actuator seated within the interior and coupled to the second locking structure and operable to drive the second locking structure toward the second end of the cross-member body in response to the second mechanical bias and engage the second locking structure with both the third opening and the fourth opening in response to the fourth opening being aligned with the third opening.

36. The cross member of claim 35, wherein the second mechanically biased release actuator is coupled to the release such that, when activated to the first activation position, the release moves the second mechanically biased release actuator against the second mechanical bias and removes the second locking structure from the fourth opening and frees the upper portion of the second elongated structure to move relative to the lower portion of the second elongated structure.

37. The cross member of claim 33, further comprising a second locking structure seated within the interior of the cross-member body having a second mechanical bias operable to drive the second locking structure toward the one end of the cross-member body, wherein the second locking structure engages a third opening in the lower portion of the first elongated structure.

38. The cross member of claim 37, wherein the second mechanical bias drives the second locking structure to engage a fourth opening in the upper portion of the first elongated structure in response to the fourth opening being aligned with the third opening to lock the upper portion of the first elongated structure in a second fixed position relative the lower portion of the first elongated structure.

39. The cross member of claim 38, wherein the fourth opening is aligned with the third opening when the second opening is not aligned with the opening, and the second fixed position of the upper portion relative to the lower portion is different from the fixed position of the upper portion relative to the lower portion.

40. The cross member of claim 38, further comprising a coupler fixedly connected at one end to the first locking structure and slidably connected at a second end to the second locking structure adjacent a flange in the second locking structure, wherein in response to the release being activated to a second activation position:
the release moves the mechanically biased release actuator further against the mechanical bias;
the first locking structure is removed further away from the one end of the cross-member body causing the coupler to slidably engage a flange on the second locking structure and drive the second locking structure against the second mechanical bias;
remove the second locking structure from the fourth opening; and
free the upper portion of the first elongated structure from the second fixed position.

41. The cross member of claim 33, further comprising a disable switch within the interior of the cross-member body having a switch actuator adjacent a crest portion of the mechanically biased release actuator, wherein in response to the release being activated to the first activation position, the crest portion of the mechanically biased release actuator engages the switch actuator and activates the disable switch, wherein an output of the disable switch is configured to deactivate a power source of the turf maintenance apparatus.

42. A base for securing an operator handle to a walk-behind turf maintenance apparatus, the base comprising:
a support structure securing the base to the walk-behind turf maintenance apparatus;
a base support secured to the support structure, the base support further comprising:
a pivot fastener for rotatably securing the operator handle to the support structure between an extended position and a folded position;
a first base stop at the extended position of the operator handle that prevents the operator handle from rotating past the extended position;
a second base stop at the folded position of the operator handle that prevents the operator handle from rotating past the folded position;
a first locking structure located at a base of the operator handle in the extended position and configured to lock the operator handle in the extended position and prevent rotation of the operator handle out of the extended position; and
a second locking structure located at the base of the operator handle in the folded position and configured to lock the operator handle in the folded position and prevent rotation of the operator handle out of the folded position.

43. The base of claim 42, wherein the first locking structure comprises a locking tab formed in the base support and configured to engage a latch in a base of the operator handle when the operator handle is positioned in the extended position.

44. The base of claim 42, wherein the second locking structure comprises a cam device formed in the base support and configured to engage a latch in a base of the operator handle, pulling the latch outward from the base of the operator handle as the operator handle is moved into the folded position, and trapping the latch when the operator handle reaches the folded position.

45. The base of claim 44, further comprising a foot stop structure that blocks the latch and the operator handle from moving to the folded position in response to the latch failing to engage the cam device.

46. The base of claim 44, further comprising a base seating pin formed on the first base stop that engages an opening in a lower portion of the operator handle in the folded position.

47. The base of claim 46, wherein the base seating pin further engages a slot opening in an upper portion of the operator handle in the folded position, wherein the slot opening permits movement of the upper portion of the operator handle by a length of the slot that allows the latch to clear the cam device and free the operator handle from the folded position.

48. The base of claim 47, further comprising a cam surface formed in the base support that pulls the latch out from the base of the operator handle as the operator handle moves from the folded position to the extended position, wherein the cam surface ends as the operator handle reaches the extended position allowing the latch to clear the cam surface and engage the first locking structure.

49. The base of claim 42, wherein the support structure is formed integrally as part of a body of the turf maintenance apparatus or fixedly fastened to the body of the turf maintenance apparatus.

50. A control interface for a walk-behind maintenance apparatus, comprising:
a housing that provides an enclosure and that provides at least one mounting surface secured to an operator handle of the walk-behind maintenance apparatus;
an electronic control unit contained within the enclosure provided by the housing and operable to manage electronic and electro-mechanical functions of the walk-behind maintenance apparatus;
an operator presence device operably coupled to the electronic control unit and having a default position and a non-default position, wherein the electronic control unit is configured to disable at least one electro-mechanical function of the electro-mechanical functions of the walk-behind maintenance apparatus in response to detecting the operator presence device in the default position; and
a command and data pathway for transmitting electrical signals between the electronic control unit and a power source and an electrical motor of the walk-behind maintenance apparatus, wherein:
the housing is secured to the operator handle adjacent a hand grip portion thereof, and
the housing is secured to the operator handle relative an operator hand position on the hand grip portion to provide a plurality of control devices within reach of the operator hand position of the hand grip portion, wherein the plurality of control devices includes two or more of: the operator presence device in the non-default position, a power actuator of the electronic control unit or a drive wheel drive actuator.

51. The control interface of claim 50, wherein the operator hand position comprises a left operator hand position and a right operator hand position and the housing is located generally between the left operator hand position and the right operator hand position.

52. The control interface of claim 51, wherein at least one of: the power actuator or the drive wheel drive actuator is located at a thumb position adjacent the left operator hand position or the right operator hand position.

53. The control interface of claim 50, wherein the plurality of control devices within reach of the operator hand position includes two or more of: the operator presence device in the non-default position, the power actuator, the drive wheel drive actuator, a drive speed selector, and a blade wear indicator reset switch.

54. The control interface of claim 50, wherein the default position of the operator presence device comprises a portion of the operator presence device that is physically displaced from the operator handle, and the non-default position comprises the portion of the operator presence device physically adjacent the hand grip portion of the operator handle.

55. The control interface of claim 50, further comprising a visual display panel providing a status indicator display for the walk-behind maintenance apparatus, the status indicator display including a batter charge level indicator.

56. The control interface of claim 55, wherein the status indicator display further includes at least one of: a cutting load level indicator, a blade wear indicator, a hand lock fault indicator or a general fault indicator.
